(19) United States
(12) Patent Application Publication
(10) Pub. No.: US 2021/0204264 A1
(43) Pub. Date: Jul. 1, 2021

(54) INFORMATION SENDING METHOD, INFORMATION RECEIVING METHOD, AND COMMUNICATIONS APPARATUS

(71) Applicant: HUAWEI TECHNOLOGIES CO., LTD., Shenzhen (CN)

(72) Inventors: Fan YANG, Beijing (CN); Xingwei ZHANG, Lund (SE)

(21) Appl. No.: 17/199,493

(22) Filed: Mar. 12, 2021

Related U.S. Application Data
(63) Continuation of application No. PCT/CN2019/104750, filed on Sep. 6, 2019.

(30) Foreign Application Priority Data
Sep. 15, 2018 (CN) 201811077477.4

(51) Int. Cl. H04W 72/04; H04L 5/00; H04L 1/18

(52) U.S. Cl. CPC H04W 72/044; H04L 1/1896; H04L 5/0005

(57) ABSTRACT

An information sending method, an information receiving method, and a communications apparatus are disclosed. The method includes: when allocating and indicating an uplink resource to a terminal, a network device may allocate and indicate, to the terminal for a feedback, a first uplink time-frequency resource used to carry a plurality of pieces of feedback information. In this way, if the terminal sends all information before the first moment, the terminal may send, on the first uplink time-frequency resource, the information that needs to be sent during the current feedback. If there is information that is not sent by the terminal because no channel is available before the first moment, the terminal may send, on the first uplink time-frequency resource, the information that needs to be sent during the current feedback and the information that is not sent previously.

### CROSS-REFERENCE TO RELATED APPLICATIONS

This application is a continuation of International Application No. PCT/CN2019/104750, filed on Sep. 6, 2019, which claims priority to Chinese Patent Application No. 201811077477.4, filed on Sep. 15, 2018. The disclosures of the aforementioned applications are hereby incorporated by reference in their entireties.

### TECHNICAL FIELD

This application relates to the field of communications technologies, and in particular, to an information sending method, an information receiving method, and a communications apparatus.

### BACKGROUND

With constant development of wireless technologies, spectrum resources of wireless communications systems are increasingly scarce, and licensed (Licensed) bands already cannot meet increasing service requirements. Unlicensed (Unlicensed) bands are used for communication in more wireless communications systems, for example, a 5^{th} generation mobile communications system (the 5^{th} generation, 5G) or a next-generation mobile communications system.

A cellular network of a 5G system needs to share a time-frequency resource in an unlicensed band with another network, for example, a wireless local area network (wireless local area network, WLAN). Therefore, according to a principle of fair access, during cellular communication between a network device and a terminal, when the network device allocates a time-frequency resource in an unlicensed band to the terminal, the terminal needs to perform listen-before-talk (listen-before-talk, LBT) detection when using the time-frequency resource in the unlicensed band. The terminal can use the time-frequency resource only when the time-frequency resource is idle.

It can be learned that, in the unlicensed band, a time-frequency resource used by the terminal to send information not only depends on the time-frequency resource allocated by the network device to the terminal, but also depends on whether the terminal can successfully access a channel on which the time-frequency resource is located. Therefore, in this case, how the network device allocates a time-frequency resource to the terminal is an urgent problem to be resolved currently.

### SUMMARY

Embodiments of this application provide an information sending method, an information receiving method, and a communications apparatus, to allocate a time-frequency resource to a terminal.

According to a first aspect, an embodiment of this application provides an information sending method. The method includes: A network device sends a first instruction used to indicate a first uplink time-frequency resource. The first uplink time-frequency resource is used to carry one or more pieces of first information and one or more pieces of second information of a terminal. The first information includes information that is not sent by the terminal before a first moment because no channel is available. The second information includes information that is transmitted on the first uplink time-frequency resource by the terminal and that is scheduled by the network device. The first uplink time-frequency resource is an uplink control channel resource and/or an uplink shared channel resource. Then, the network device receives at least one piece of the one or more pieces of first information and the one and more pieces of second information on the first uplink time-frequency resource.

In the foregoing technical solution, when allocating and indicating an uplink resource to the terminal, the network device may allocate and indicate, to the terminal for a feedback, the first uplink time-frequency resource used to carry a plurality of pieces of feedback information. For example, the first uplink time-frequency resource may be used to carry the information that is not sent by the terminal before the first moment of the current feedback because no channel is available, and information that needs to be fed back by the terminal during the current feedback. In this way, if the terminal sends all information before the first moment, the terminal may send, on the first uplink time-frequency resource, the information that needs to be sent during the current feedback. If there is information that is not sent by the terminal because no channel is available before the first moment, the terminal may send, on the first uplink time-frequency resource, the information that needs to be sent during the current feedback and the information that is not sent previously. This can deal with resource configuration when a quantity of bits carried by an uplink resource changes due to availability of a channel.

In a possible design, a first field of the first instruction is used to indicate that the first uplink time-frequency resource is a resource in a first resource set. The first resource set is determined based on a quantity of bits of the one or more pieces of first information and the one and more pieces of second information. The quantity of bits is a sum of a quantity of bits of the one or more pieces of first information and a quantity of bits of the one and more pieces of second information, or is a larger quantity of bits of a quantity of bits of the one or more pieces of first information and a quantity of bits of the one and more pieces of second information.

In the foregoing technical solution, the network device may configure a plurality of resource sets for the terminal, then determine the resource set of the first uplink time-frequency resource in the configured plurality of resource sets based on the quantity of bits of the one or more pieces of first information and the one or more pieces of second information, and then indicate a location of the first uplink time-frequency resource in the first resource set by using the first field. Therefore, an indication manner is simple. In addition, because the first uplink time-frequency resource is determined based on the quantity of bits of the one or more pieces of first information and the one or more pieces of second information, it can be ensured that the first uplink time-frequency resource can carry the one or more pieces of first information and the one or more pieces of second information.

In a possible design, a second field of the first instruction is used to indicate a second uplink time-frequency resource in a second resource set. The second resource set is determined based on the quantity of bits of the one or more pieces of second information. If the second resource set is determined based on a quantity of bits of the plurality of pieces of second information, the quantity of bits is a sum of quantities of bits of the plurality of pieces of second information or is a largest quantity of bits of quantities of bits of the plurality of pieces of second information.

In the foregoing technical solution, the second uplink time-frequency resource specially used to carry the one or more pieces of second information may be further indicated by using the first instruction. In this way, if the terminal needs to send only the one or more pieces of second information, the terminal may send the one or more pieces of second information on the second uplink time-frequency resource. Further, the second field used to indicate the second uplink time-frequency resource may be different from the first field. In this way, the second uplink time-frequency resource may be indicated explicitly. Alternatively, the second field may be the same as the first field. In this way, the second uplink time-frequency resource may be indicated implicitly, and no new field needs to be added and an implementation is simple.

In a possible design, that the first uplink time-frequency resource carries the one or more pieces of first information and the one and more pieces of second information of the terminal may include, but is not limited to, the following plurality of manners.

In a first manner, the first uplink time-frequency resource is used to carry the one or more pieces of first information and the one and more pieces of second information, and the one or more pieces of first information and the one and more pieces of second information are included in a same HARQ-ACK codebook.

In a second manner, the first uplink time-frequency resource is used to carry information that is obtained after the one or more pieces of first information and the one and more pieces of second information are jointly encoded, and the one or more pieces of first information and the one and more pieces of second information are included in different HARQ-ACK codebooks.

In a third manner, the first uplink time-frequency resource is used to carry information that is obtained after the one or more pieces of first information and the one and more pieces of second information are separately encoded, and the one or more pieces of first information and the one and more pieces of second information are included in different HARQ-ACK codebooks.

In a fourth manner, the first uplink time-frequency resource is used to carry information that is obtained after a logical operation is performed on the one or more pieces of first information and the one and more pieces of second information.

In the foregoing technical solution, the first information and the second information may be carried on the first uplink time-frequency resource in a plurality of manners, so that flexibility of a communications system can be improved.

In a possible design, each piece of the one or more pieces of first information and the one and more pieces of second information is HARQ information used to perform feedback for a received downlink signal or CSI information used to estimate a channel state.

In the foregoing technical solution, the first information and the second information may be a plurality of different types of information, so that applicability of the information receiving method provided in this embodiment of this application can be improved.

According to a second aspect, an embodiment of this application provides an information sending method. The method includes: A terminal receives a first instruction used to indicate a first uplink time-frequency resource. The first uplink time-frequency resource is used to carry one or more pieces of first information and one and more pieces of second information of the terminal. The first information includes information that is not sent by the terminal before a first moment because no channel is available. The second information includes information that is transmitted on the first uplink time-frequency resource by the terminal and that is scheduled by the network device. The first uplink time-frequency resource is an uplink control channel resource and/or an uplink shared channel resource. Then, the terminal sends at least one piece of the one or more pieces of first information and the one and more pieces of second information on the first uplink time-frequency resource after a channel is available.

In the foregoing technical solution, the first uplink time-frequency resource that is obtained by the terminal for a feedback may be used to carry a plurality of pieces of feedback information. For example, the first uplink time-frequency resource may be used to carry the information that is not sent by the terminal before the first moment of the current feedback because no channel is available, and information that needs to be fed back by the terminal during the current feedback. In this way, if the terminal sends all information before the first moment, the terminal may send, on the first uplink time-frequency resource, the information that needs to be sent during the current feedback. If there is information that is not sent by the terminal because no channel is available before the first moment, the terminal may send, on the first uplink time-frequency resource, the information that needs to be sent during the current feedback and the information that is not sent previously. Regardless of a type of message sent by the terminal, the first uplink time-frequency resource can carry the type of message. Therefore, this can deal with resource configuration when a quantity of bits carried by an uplink resource changes due to availability of a channel.

In a possible design, a first field of the first instruction is used to indicate that the first uplink time-frequency resource is a resource in a first resource set. The first resource set is determined based on a quantity of bits of the one or more pieces of first information and the one and more pieces of second information. The quantity of bits is a sum of a quantity of bits of the one or more pieces of first information and a quantity of bits of the one and more pieces of second information, or is a larger quantity of bits of a quantity of bits of the one or more pieces of first information and a quantity of bits of the one and more pieces of second information.

In the foregoing technical solution, the network device may configure a plurality of resource sets for the terminal. Then, after receiving the first instruction, the terminal may determine the resource set of the first uplink time-frequency resource in the configured plurality of resource sets based on the quantity of bits of the one or more pieces of first information and the one or more pieces of second information, and then determine the first uplink time-frequency resource in the first resource set by using the first field. Therefore, a determining manner is simple.

In a possible design, a second field of the first instruction is used to indicate a second uplink time-frequency resource in a second resource set. The second resource set is determined based on the quantity of bits of the one or more pieces of second information. If the second resource set is determined based on a quantity of bits of the plurality of pieces of second information, the quantity of bits is a sum of quantities of bits of the plurality of pieces of second information or is a largest quantity of bits of quantities of bits of the plurality of pieces of second information.

In the foregoing technical solution, the terminal may further determine, based on the first instruction, the second uplink time-frequency resource specially used to carry the one or more pieces of second information. In this way, if the terminal needs to send only the one or more pieces of second information, the terminal may send the one or more pieces of second information on the second uplink time-frequency resource.

In a possible design, the terminal sends the at least one piece of information on the first uplink time-frequency resource in the following two sending manners, which are not limited thereto.

The terminal may use the channel after the first moment. If the first information is not sent before the first moment, the terminal sends the one or more pieces of first information and the one and more pieces of second information on the first uplink time-frequency resource.

Alternatively, the terminal may use the channel after the first moment. If the first information is sent before the first moment, the terminal sends the one or more pieces of second information on the second uplink time-frequency resource.

In the foregoing technical solution, if the terminal sends all information before the first moment, the terminal may send, on the second uplink time-frequency resource, the information that needs to be sent during the current feedback. If there is information that is not sent by the terminal because no channel is available before the first moment, the terminal may send, on the first uplink time-frequency resource, the information that needs to be sent during the current feedback and the information that is not sent previously. In this way, because the two uplink resources are configured, this can deal with resource configuration when a quantity of bits carried by an uplink resource changes due to availability of a channel.

In a possible design, the terminal sends the one or more pieces of second information on the first uplink time-frequency resource in the following two manners, which are not limited thereto.

Preset information is sent at a first resource location and the one or more pieces of second information is sent at a second resource location. The first resource location is a resource location reserved for the one or more pieces of first information. The second resource location is a remaining resource location on the first uplink time-frequency resource other than the first resource location.

Alternatively, combined information of the one or more pieces of second information and preset information is sent on the first uplink time-frequency resource.

The preset information is an acknowledgment ACK message, a negative acknowledgment NACK message, or a combination of an ACK and a NACK.

In the foregoing technical solution, the terminal may send the second information on the first uplink time-frequency resource in a plurality of manners, so that flexibility of the terminal can be improved.

In a possible design, that the first uplink time-frequency resource carries the one or more pieces of first information and the one and more pieces of second information of the terminal may include, but is not limited to, the following plurality of manners:

In a first manner, the first uplink time-frequency resource is used to carry the one or more pieces of first information and the one and more pieces of second information, and the one or more pieces of first information and the one and more pieces of second information are included in a same HARQ-ACK codebook.

In a second manner, the first uplink time-frequency resource is used to carry information that is obtained after the one or more pieces of first information and the one and more pieces of second information are jointly encoded, and the one or more pieces of first information and the one and more pieces of second information are included in different HARQ-ACK codebooks.

In a third manner, the first uplink time-frequency resource is used to carry information that is obtained after the one or more pieces of first information and the one and more pieces of second information are separately encoded, and the one or more pieces of first information and the one and more pieces of second information are included in different HARQ-ACK codebooks.

In a fourth manner, the first uplink time-frequency resource is used to carry information that is obtained after a logical operation is performed on the one or more pieces of first information and the one and more pieces of second information.

In the foregoing technical solution, the first information and the second information may be carried on the first uplink time-frequency resource in a plurality of manners, so that flexibility of a communications system can be improved.

In a possible design, each piece of the one or more pieces of first information and the one and more pieces of second information is HARQ information used to perform feedback for a received downlink signal or CSI information used to estimate a channel state.

In the foregoing technical solution, the first information and the second information may be a plurality of different types of information, so that applicability of the information receiving method provided in this embodiment of this application can be improved.

According to a third aspect, an embodiment of this application provides a communications apparatus. The communications apparatus includes a processor, configured to implement the method according to the first aspect. The communications apparatus may further include a memory, configured to store a program instruction and data. The memory is coupled to the processor. The processor may invoke and execute the program instruction stored in the memory, to implement any one of the methods according to the first aspect. The communications apparatus may further include a communications interface. The communications interface is used by the communications apparatus to communicate with another device. For example, the another device is a terminal.

In a possible design, the communications apparatus includes the processor and the communications interface.

Under control of the processor, the communications interface sends a first instruction. The first instruction is used to indicate a first uplink time-frequency resource. The first uplink time-frequency resource is used to carry one or more pieces of first information and one or more pieces of second information of the terminal.

The first information includes information that is not sent by the terminal before a first moment because no channel is available. The second information includes information that is transmitted on the first uplink time-frequency resource by the terminal and that is scheduled by the communications apparatus. The first uplink time-frequency resource is an uplink control channel resource and/or an uplink shared channel resource.

The communications interface receives at least one piece of the one or more pieces of first information and the one and more pieces of second information on the first uplink time-frequency resource.

In a possible design, a first field of the first instruction is used to indicate that the first uplink time-frequency resource is a resource in a first resource set. The first resource set is determined based on a quantity of bits of the one or more pieces of first information and the one and more pieces of second information. The quantity of bits is a sum of a quantity of bits of the one or more pieces of first information and a quantity of bits of the one and more pieces of second information, or is a larger quantity of bits of a quantity of bits of the one or more pieces of first information and a quantity of bits of the one and more pieces of second information.

In a possible design, a second field of the first instruction is used to indicate a second uplink time-frequency resource in a second resource set. The second resource set is determined based on the quantity of bits of the one or more pieces of second information. If the second resource set is determined based on a quantity of bits of the plurality of pieces of second information, the quantity of bits is a sum of quantities of bits of the plurality of pieces of second information or is a largest quantity of bits of quantities of bits of the plurality of pieces of second information.

In a possible design, that the first uplink time-frequency resource is used to carry the one or more pieces of first information and the one and more pieces of second information of the terminal includes:

the first uplink time-frequency resource is used to carry the one or more pieces of first information and the one and more pieces of second information, and the one or more pieces of first information and the one and more pieces of second information are included in a same HARQ-ACK codebook;

the first uplink time-frequency resource is used to carry information that is obtained after the one or more pieces of first information and the one and more pieces of second information are jointly encoded, and the one or more pieces of first information and the one and more pieces of second information are included in different HARQ-ACK codebooks;

the first uplink time-frequency resource is used to carry information that is obtained after the one or more pieces of first information and the one and more pieces of second information are separately encoded, and the one or more pieces of first information and the one and more pieces of second information are included in different HARQ-ACK codebooks; or

the first uplink time-frequency resource is used to carry information that is obtained after a logical operation is performed on the one or more pieces of first information and the one and more pieces of second information.

In a possible design, each piece of the one or more pieces of first information and the one and more pieces of second information is HARQ information used to perform feedback for a received downlink signal or CSI information used to estimate a channel state.

According to a fourth aspect, an embodiment of this application provides a communications apparatus. The communications apparatus includes a processor, configured to implement the method according to the second aspect. The communications apparatus may further include a memory, configured to store a program instruction and data. The memory is coupled to the processor. The processor may invoke and execute the program instruction stored in the memory, to implement any one of the methods according to the second aspect. The communications apparatus may further include a communications interface. The communications interface is used by the communications apparatus to communicate with another device. For example, the another device is a network device.

In a possible design, the communications apparatus includes the processor and the communications interface.

The communications interface receives a first instruction. The first instruction is used to indicate a first uplink time-frequency resource. The first uplink time-frequency resource is used to carry one or more pieces of first information and one and more pieces of second information of the communications apparatus.

The first information includes information that is not sent by the communications apparatus before a first moment because no channel is available. The second information includes information that is transmitted on the first uplink time-frequency resource by the communications apparatus and that is scheduled by the network device. The first uplink time-frequency resource is an uplink control channel resource and/or an uplink shared channel resource.

Under control of the processor, the communications interface sends at least one piece of the one or more pieces of first information and the one and more pieces of second information on the first uplink time-frequency resource after a channel is available.

In a possible design, a first field of the first instruction is used to indicate that the first uplink time-frequency resource is a resource in a first resource set. The first resource set is determined based on a quantity of bits of the one or more pieces of first information and the one and more pieces of second information. The quantity of bits is a sum of a quantity of bits of the one or more pieces of first information and a quantity of bits of the one and more pieces of second information, or is a larger quantity of bits of a quantity of bits of the one or more pieces of first information and a quantity of bits of the one and more pieces of second information.

In a possible design, a second field of the first instruction is used to indicate a second uplink time-frequency resource in a second resource set. The second resource set is determined based on the quantity of bits of the one or more pieces of second information. If the second resource set is determined based on a quantity of bits of the plurality of pieces of second information, the quantity of bits is a sum of quantities of bits of the plurality of pieces of second information or is a largest quantity of bits of quantities of bits of the plurality of pieces of second information.

In a possible design, the first information is not sent before the first moment. Under control of the processor, the communications interface sends the one or more pieces of first information and the one and more pieces of second information on the first uplink time-frequency resource.

In a possible design, the first information is sent before the first moment. Under control of the processor, the communications interface sends the one or more pieces of second information on the second uplink time-frequency resource.

In a possible design, under control of the processor, the communications interface sends preset information at a first resource location and sends the one or more pieces of second information at a second resource location, where the first resource location is a resource location reserved for the one or more pieces of first information, and the second resource location is a remaining resource location in the first uplink time-frequency resource other than the first resource location; or

sends combined information of the one or more pieces of second information and preset information on the first uplink time-frequency resource; where

the preset information is an acknowledgment ACK message, a negative acknowledgment NACK message, or a combination of an ACK and a NACK.

In a possible design, the first uplink time-frequency resource is used to carry the one or more pieces of first information and the one and more pieces of second information, and the one or more pieces of first information and the one and more pieces of second information are included in a same HARQ-ACK codebook;

the first uplink time-frequency resource is used to carry information that is obtained after the one or more pieces of first information and the one and more pieces of second information are jointly encoded, and the one or more pieces of first information and the one and more pieces of second information are included in different HARQ-ACK codebooks;

the first uplink time-frequency resource is used to carry information that is obtained after the one or more pieces of first information and the one and more pieces of second information are separately encoded, and the one or more pieces of first information and the one and more pieces of second information are included in different HARQ-ACK codebooks; or

the first uplink time-frequency resource is used to carry information that is obtained after a logical operation is performed on the one or more pieces of first information and the one and more pieces of second information.

In a possible design, each first information of the one or more pieces of first information and the one and more pieces of second information is information used to perform feedback for a received downlink signal or information used to estimate a channel state.

According to a fifth aspect, an embodiment of this application provides a communications apparatus. The communications apparatus may be a network device, or may be an apparatus in a network device. The communications apparatus may include a processing module and a communications module. These modules may perform corresponding functions performed by the network device in any design example of the first aspect. Specifics are as follows:

The communications module is configured to: under control of the processing module, send a first instruction. The first instruction is used to indicate a first uplink time-frequency resource. The first uplink time-frequency resource is used to carry one or more pieces of first information and one or more pieces of second information of a terminal.

The first information includes information that is not sent by the terminal before a first moment because no channel is available. The second information includes information that is transmitted on the first uplink time-frequency resource by the terminal and that is scheduled by the network device. The first uplink time-frequency resource is an uplink control channel resource and/or an uplink shared channel resource.

The communications module is further configured to receive at least one piece of the one or more pieces of first information and the one and more pieces of second information on the first uplink time-frequency resource.

In a possible design, a first field of the first instruction is used to indicate that the first uplink time-frequency resource is a resource in a first resource set. The first resource set is determined based on a quantity of bits of the one or more pieces of first information and the one and more pieces of second information. The quantity of bits is a sum of a quantity of bits of the one or more pieces of first information and a quantity of bits of the one and more pieces of second information, or is a larger quantity of bits of a quantity of bits of the one or more pieces of first information and a quantity of bits of the one and more pieces of second information.

In a possible design, a second field of the first instruction is used to indicate a second uplink time-frequency resource in a second resource set. The second resource set is determined based on the quantity of bits of the one or more pieces of second information. If the second resource set is determined based on a quantity of bits of the plurality of pieces of second information, the quantity of bits is a sum of quantities of bits of the plurality of pieces of second information or is a largest quantity of bits of quantities of bits of the plurality of pieces of second information.

In a possible design, that the first uplink time-frequency resource is used to carry the one or more pieces of first information and the one and more pieces of second information of the terminal includes:

the first uplink time-frequency resource is used to carry the one or more pieces of first information and the one and more pieces of second information, and the one or more pieces of first information and the one and more pieces of second information are included in a same HARQ-ACK codebook;

the first uplink time-frequency resource is used to carry information that is obtained after the one or more pieces of first information and the one and more pieces of second information are jointly encoded, and the one or more pieces of first information and the one and more pieces of second information are included in different HARQ-ACK codebooks;

the first uplink time-frequency resource is used to carry information that is obtained after the one or more pieces of first information and the one and more pieces of second information are separately encoded, and the one or more pieces of first information and the one and more pieces of second information are included in different HARQ-ACK codebooks; or

the first uplink time-frequency resource is used to carry information that is obtained after a logical operation is performed on the one or more pieces of first information and the one and more pieces of second information.

In a possible design, each piece of the one or more pieces of first information and the one and more pieces of second information is HARQ information used to perform feedback for a received downlink signal or CSI information used to estimate a channel state.

According to a sixth aspect, an embodiment of this application provides a communications apparatus. The communications apparatus may be a terminal, or may be an apparatus in a terminal. The communications apparatus may include a processing module and a communications module. These modules may perform corresponding functions performed by the terminal in any design example of the second aspect. Specifics are as follows:

The communications module is configured to receive a first instruction. The first instruction is used to indicate a first uplink time-frequency resource. The first uplink time-frequency resource is used to carry one or more pieces of first information and one and more pieces of second information of the terminal.

The first information includes information that is not sent by the terminal before a first moment because no channel is available. The second information includes information that is transmitted on the first uplink time-frequency resource by the terminal and that is scheduled by the network device. The first uplink time-frequency resource is an uplink control channel resource and/or an uplink shared channel resource.

The communications module is further configured to: under control of the processing module, send at least one piece of the one or more pieces of first information and the one and more pieces of second information on the first uplink time-frequency resource after a channel is available.

In a possible design, a first field of the first instruction is used to indicate that the first uplink time-frequency resource is a resource in a first resource set. The first resource set is determined based on a quantity of bits of the one or more pieces of first information and the one and more pieces of second information. The quantity of bits is a sum of a quantity of bits of the one or more pieces of first information and a quantity of bits of the one and more pieces of second information, or is a larger quantity of bits of a quantity of bits of the one or more pieces of first information and a quantity of bits of the one and more pieces of second information.

In a possible design, a second field of the first instruction is used to indicate a second uplink time-frequency resource in a second resource set. The second resource set is determined based on the quantity of bits of the one or more pieces of second information. If the second resource set is determined based on a quantity of bits of the plurality of pieces of second information, the quantity of bits is a sum of quantities of bits of the plurality of pieces of second information or is a largest quantity of bits of quantities of bits of the plurality of pieces of second information.

In a possible design, the terminal may use the channel after the first moment. The communications module is specifically configured to: if the first information is not sent before the first moment, send the one or more pieces of first information and the one and more pieces of second information on the first uplink time-frequency resource.

In a possible design, the terminal may use the channel after the first moment. The communications module is specifically configured to: send the first information before the first moment, and send the one or more pieces of second information on the second uplink time-frequency resource.

In a possible design, the communications module is specifically configured to: send preset information at a first resource location and send the one or more pieces of second information at a second resource location, where the first resource location is a resource location reserved for the one or more pieces of first information, and the second resource location is a remaining resource location in the first uplink time-frequency resource other than the first resource location; or send combined information of the one or more pieces of second information and preset information on the first uplink time-frequency resource. The preset information is an acknowledgment ACK message, a negative acknowledgment NACK message, or a combination of an ACK and a NACK.

In a possible design, that the first uplink time-frequency resource is used to carry the one or more pieces of first information and the one or more pieces of second information of the terminal includes:

the first uplink time-frequency resource is used to carry the one or more pieces of first information and the one and more pieces of second information, and the one or more pieces of first information and the one and more pieces of second information are included in a same HARQ-ACK codebook;

the first uplink time-frequency resource is used to carry information that is obtained after the one or more pieces of first information and the one and more pieces of second information are jointly encoded, and the one or more pieces of first information and the one and more pieces of second information are included in different HARQ-ACK codebooks;

the first uplink time-frequency resource is used to carry information that is obtained after the one or more pieces of first information and the one and more pieces of second information are separately encoded, and the one or more pieces of first information and the one and more pieces of second information are included in different HARQ-ACK codebooks; or

the first uplink time-frequency resource is used to carry information that is obtained after a logical operation is performed on the one or more pieces of first information and the one and more pieces of second information.

In a possible design, each first information of the one or more pieces of first information and the one and more pieces of second information is information used to perform feedback for a received downlink signal or information used to estimate a channel state.

According to a seventh aspect, an embodiment of this application further provides a computer readable storage medium, including an instruction. When the instruction is run on a computer, the computer is enabled to perform the method according to the first aspect.

According to an eighth aspect, an embodiment of this application further provides a computer readable storage medium, including an instruction. When the instruction is run on a computer, the computer is enabled to perform the method according to the second aspect.

According to a ninth aspect, an embodiment of this application further provides a computer program product, including an instruction. When the computer program product is run on a computer, the computer is enabled to perform the method according to the first aspect.

According to a tenth aspect, an embodiment of this application further provides a computer program product, including an instruction. When the computer program product is run on a computer, the computer is enabled to perform the method according to the second aspect.

According to an eleventh aspect, an embodiment of this application provides a chip system. The chip system includes a processor and may further include a memory, and is configured to implement the method according to the first aspect. The chip system may include a chip, or may include a chip and another discrete device.

According to a twelfth aspect, an embodiment of this application provides a chip system. The chip system includes a processor and may further include a memory, and is configured to implement the method according to the second aspect. The chip system may include a chip, or may include a chip and another discrete device.

According to a thirteenth aspect, an embodiment of this application provides a system. The system includes the communications apparatus according to the third aspect and the communications apparatus according to the fourth aspect.

According to a fourteenth aspect, an embodiment of this application provides a system. The system includes the communications apparatus according to the fifth aspect and the communications apparatus according to the sixth aspect.

For beneficial effects of the third aspect to the fourteenth aspect and implementations thereof, refer to descriptions of beneficial effects of the methods according to the first aspect and the second aspect and implementations thereof.

### BRIEF DESCRIPTION OF DRAWINGS

FIG. 1 is a diagram of a network architecture according to an embodiment of this application;

FIG. 2 is a flowchart of an example of an information receiving and sending method according to an embodiment of this application;

FIG. 3A is a schematic diagram of a first manner of understanding a channel on which a third uplink time-frequency resource is located according to an embodiment of this application;

FIG. 3B is a schematic diagram of a second manner of understanding a channel on which a third uplink time-frequency resource is located according to an embodiment of this application;

FIG. 3C is a schematic diagram of a first location relationship between a first uplink time-frequency resource and a third uplink time-frequency resource according to an embodiment of this application;

FIG. 3D is a schematic diagram of a second location relationship between a first uplink time-frequency resource and a third uplink time-frequency resource according to an embodiment of this application;

FIG. 3E is a schematic diagram of sending HARQ 1 information by a terminal on a third uplink time-frequency resource according to an embodiment of this application;

FIG. 4 is a flowchart of another example of an information receiving and sending method according to an embodiment of this application;

FIG. 5 is a schematic diagram of sending HARQ 1 information and HARQ 2 information by a terminal on a first uplink time-frequency resource according to an embodiment of this application;

FIG. 6 is a flowchart of another example of an information receiving and sending method according to an embodiment of this application;

FIG. 7A is a schematic diagram of an example of a first uplink time-frequency resource and a second uplink time-frequency resource according to an embodiment of this application;

FIG. 7B is a schematic diagram of another example of a first uplink time-frequency resource and a second uplink time-frequency resource according to an embodiment of this application;

FIG. 7C is a schematic diagram of sending HARQ 1 information by a terminal on a third uplink time-frequency resource and sending HARQ 2 information on a second uplink time-frequency resource according to an embodiment of this application;

FIG. 7D is a schematic diagram of a first location relationship among a first uplink time-frequency resource, a second uplink time-frequency resource, and a third uplink time-frequency resource according to an embodiment of this application;

FIG. 7E is a schematic diagram of a second location relationship among a first uplink time-frequency resource, a second uplink time-frequency resource, and a third uplink time-frequency resource according to an embodiment of this application;

FIG. 8 is a flowchart of another example of an information receiving and sending method according to an embodiment of this application;

FIG. 9 is a schematic diagram of sending HARQ 1 information and HARQ 2 information by a terminal on a first uplink time-frequency resource according to an embodiment of this application;

FIG. 10 is a schematic structural diagram of a communications apparatus according to an embodiment of this application;

FIG. 11 is a schematic structural diagram of another communications apparatus according to an embodiment of this application;

FIG. 12 is a schematic structural diagram of another communications apparatus according to an embodiment of this application; and

FIG. 13 is a schematic structural diagram of another communications apparatus according to an embodiment of this application.

### DESCRIPTION OF EMBODIMENTS

To make objectives, technical solutions, and advantages of the embodiments of this application clearer, the following describes the technical solutions in the embodiments of this application in detail with reference to the accompanying drawings and specific implementations of the specification.

In the following, some terms of the embodiments of this application are described, to help a person skilled in the art have a better understanding.

(1) A terminal is also referred to as a terminal device, user equipment (user equipment, UE), a mobile station (mobile station, MS), a mobile terminal (mobile terminal, MT), or the like, and is a device that provides voice and/or data connectivity for a user, for example, may include a handheld device with a wireless connection function or a processing device connected to a wireless modem. The terminal may communicate with a core network by using a radio access network (radio access network, RAN) and exchange voice and/or data with the RAN. The terminal may be referred to as user equipment (user equipment, UE), a wireless terminal, a mobile terminal, a subscriber unit (subscriber unit), a subscriber station (subscriber station), a mobile station (mobile station), a mobile console (mobile), a remote station (remote station), an access point (access point, AP), a remote terminal (remote terminal), an access terminal (access terminal), a user terminal device (user terminal), a user agent (user agent), a user device (user device), or the like. The terminal may include, for example, a mobile phone (or referred to as a “cellular” phone), a computer with a mobile terminal, a portable, pocket-sized, handheld, computer built-in, or in-vehicle mobile apparatus, or a smart wearable device. For example, it may be a device such as a personal communication service (personal communication service, PCS) phone, a cordless telephone set, a session initiation protocol (session initiation protocol, SIP) phone, a wireless local loop (wireless local loop, WLL) station, or a personal digital assistant (personal digital assistant, PDA). The terminal further includes a limited device, for example, a device with relatively low power consumption, or a device with a limited storage capability, or a device with a limited computing capability, and includes, for example, an information sensing device such as a barcode, a radio frequency identification (radio frequency identification, RFID), a sensor, a global positioning system (global positioning system, GPS), and a laser scanner.

As a non-limitative example, in the embodiments of this application, the terminal may be further a wearable device. The wearable device may also be referred to as a smart wearable device, is a general term of wearable devices developed by smartly designing daily wear with a wearable technology, and is, for example, glasses, gloves, a watch, clothing, and shoes. The wearable device is a portable device that is directly worn on a body or integrated into clothing or an accessory of a user. The wearable device not only is a hardware device, but also performs powerful functions through software support, data interaction, and cloud interaction. In a broad sense, the smart wearable device includes, for example, a smartwatch or smart glasses that have full functions and large sizes and that can perform some or all functions without relying on a smartphone, and various smart bands, smart helmets, or smart jewelries that focus only on a specific type of application function and need to be used in cooperation with another device such as a smartphone and that monitor physical signs. The terminal may also be a virtual reality (virtual reality, VR) device, an augmented reality (augmented reality, AR) device, a wireless terminal in industrial control (industrial control), a wireless terminal in self driving (self driving), a wireless terminal in remote medical surgery (remote medical surgery), a wireless terminal in a smart grid (smart grid), a wireless terminal in transportation safety (transportation safety), a wireless terminal in a smart city (smart city), a wireless terminal in a smart home (smart home), and the like.

2. The network device may be a base station (for example, an access point). The base station may specifically refer to a device in communication with a wireless terminal via one or more sectors at an air interface in an access network. The network device may be configured to mutually convert a received over-the-air frame and an Internet Protocol (IP) packet and serve as a router between the terminal and a rest portion of the access network, where the rest portion of the access network may include an IP network. The network device may coordinate attribute management of the air interface. For example, the network device may include a radio network controller (radio network controller, RNC), a NodeB (NodeB, NB), a base station controller (base station controller, BSC), a base transceiver station (base transceiver station, BTS), a home NodeB (for example, a home evolved NodeB or a home Node B, HNB), a base band unit (base band unit, BBU), a wireless fidelity (wireless fidelity, Wi-Fi) access point (access point, AP), or the like, or may include an evolved NodeB (NodeB or eNB or e-NodeB, evolved NodeB) in a long term evolution (long term evolution, LTE) system or an LTE-advanced (LTE-Advanced, LTE-A) system, or may include a next generation node B (next generation node B, gNB) in a fifth generation mobile communications technology (fifth generation, 5G) new radio (new radio, NR) system, or may include a centralized unit (centralized unit, CU) and a distributed unit (distributed unit, DU) in a cloud radio access network (cloud radio access network, Cloud RAN) system. This is not limited in the embodiments of this application.

(3) Time-frequency resource. A time-frequency resource in a wireless communications system is usually described in a unit of a physical resource block (physical resource block, PRB) or an RB. One PRB includes two slots (slot) in time domain, that is, 14 orthogonal frequency division multiple (Orthogonal Frequency Division Multiple, OFDM) symbols, and includes 12 subcarriers in frequency domain. One PRB includes two adjacent RBs, that is, one RB includes 12 subcarriers in frequency domain and includes one slot in time domain. It should be noted that terms “time-frequency resource” and “resource” in the embodiments of this application may be used interchangeably.

(4) An uplink control channel may be a physical uplink control channel (physical uplink control channel, PUCCH), a machine type communication physical uplink control channel (MTC physical uplink control channel, MPUCCH), a narrowband physical uplink control channel (Narrowband physical uplink control channel, NPUCCH), or the like.

(5) An uplink shared channel may be a physical uplink shared channel (physical uplink shared channel, PUSCH), a machine type communication physical uplink shared channel (MTC physical uplink shared channel, MPUSCH), a narrowband physical uplink shared channel (Narrowband physical uplink shared channel, NPUSCH), or the like.

(6) A downlink signal may be downlink data or downlink signaling. A terminal performs HARQ feedback for downlink data or downlink signaling sent by a network device. For example, the downlink data may be data transmitted on a PDSCH. The downlink signaling may be signaling transmitted on a PDCCH, for example, downlink control information (downlink control information, DCI) signaling for semi-persistent downlink shared channel release (semi-persistent release, SPS PDSCH release). In the following embodiments, an example in which the downlink signal is the downlink data is used for description. However, it may be understood that if the terminal performs feedback for the downlink signaling sent by the network device, an implementation thereof is similar.

(7) In the embodiments of this application, “a plurality of” means two or more. In view of this, in the embodiments of this application, “a plurality of” may also be understood as “at least two”. “At least one” may be understood as one or more, for example, understood as one, two, or more. For example, “including at least one” means including one, two, or more. In addition, items included are not limited. For example, including at least one of A, B, or C means that A, B, C, A and B, A and C, B and C, or A, B, and C may be included. The term “and/or” describes an association relationship for describing associated objects and represents that three relationships may exist. For example, A and/or B may represent the following three cases: Only A exists, both A and B exist, and only B exists. In addition, the character “I” generally indicates an “or” relationship between the associated objects. The terms “system” and “network” may be used interchangeably in the embodiments of this application.

Unless otherwise stated, ordinal terms such as “first” and “second” mentioned in the embodiments of this application are intended to distinguish a plurality of objects, and are not intended to limit an order, a time sequence, priorities, or importance degrees of the plurality of objects.

In a licensed band, a terminal performs cellular communication with a network device on a time-frequency resource indicated by the network device. For example, the network device allocates and indicates, to the terminal, a time-frequency resource used to send channel state information (channel state information, CSI) and hybrid automatic repeat request acknowledgment (hybrid automatic repeat request acknowledgment, HARQ-ACK) information. Therefore, the terminal sends corresponding information on the indicated time-frequency resource. For example, the network device sends, by using a physical downlink shared channel (physical downlink shared channel, PDSCH), downlink data on a time-frequency resource whose time-domain location is a slot n, and instructs, by using a physical downlink control channel (physical downlink control channel, PDCCH), the terminal to feed back HARQ information on a time-frequency resource whose time-domain location is a slot (n+k). In this way, when receiving the data on the time-frequency resource whose time-domain location is the slot n, the terminal feeds back the HARQ-ACK information on the time-frequency resource whose time-domain location is the slot (n+k). For ease of description, the HARQ-ACK information is represented by HARQ information below, that is, the HARQ-ACK information and the HARQ information may be used interchangeably.

However, all unlicensed bands are shared, that is, a cellular network may use an unlicensed band and a WLAN network may also use the unlicensed band. As can be seen, in an unlicensed band, when a terminal performs cellular communication with a network device, whether the terminal can send HARQ-ACK information not only depends on a time-frequency resource allocated by the network device to the terminal, but also depends on whether a channel on which the time-frequency resource is located is available before (when) the terminal sends the HARQ-ACK information. Whether the channel of the time-frequency resource is available may be as follows: if the channel of the time-frequency resource is not occupied by another network device or another terminal, that is, the channel is in an idle state, the terminal may use the channel and feed back HARQ information on the resource configured by the network device. If the channel of the time-frequency resource is occupied, the terminal cannot use the channel, and the time-frequency resource is also unavailable. Therefore, in this case, how the network device allocates a time-frequency resource to the terminal is an urgent problem to be resolved currently.

In view of this, the technical solutions in the embodiments of this application are provided. In the embodiments of this application, when allocating and indicating an uplink resource to a terminal, a network device may allocate and indicate, to the terminal for a feedback (for example, feedback of HARQ-ACK information), one or more first uplink time-frequency resources used to carry a plurality of pieces of feedback information. For example, the first uplink time-frequency resource may be used to carry information that is not sent by the terminal before a first moment of the current feedback because no channel is available, and information that needs to be fed back by the terminal during the current feedback. The first moment may correspond to the first symbol of the first uplink time-frequency resource, or may be an N^{th} symbol before the first uplink time-frequency resource, where N is a positive integer. N may be a predefined value, or may change based on different subcarrier spacings. For example, the first moment may correspond to a start boundary of the first symbol of the first uplink time-frequency resource, or the first moment may correspond to a start boundary of N^{th} symbol before the first uplink time-frequency resource. In this way, if the terminal sends all information before the first moment, the terminal may send, on the first uplink time-frequency resource, the information that needs to be sent during the current feedback. If there is information that is not sent by the terminal because no channel is available before the first moment, the terminal may send, on the first uplink time-frequency resource, the information that needs to be sent during the current feedback and the information that is not sent previously. This can deal with resource configuration when a quantity of bits carried by an uplink resource changes due to availability of a channel.

The technical solutions provided in the embodiments of this application may be applied to a 5G system, a long term evolution-advanced (long term evolution-advanced, LTE-A) system, a worldwide interoperability for microwave access (worldwide interoperability for microwave access, WiMAX) system, a wireless local area network (wireless local area network, WLAN) system, or the like.

In addition, the communications system may be further applicable to a future-oriented communications technology. The system described in the embodiments of this application is intended to describe the technical solutions in the embodiments of this application more clearly, and do not constitute a limitation on the technical solutions provided in the embodiments of this application. A person of ordinary skill in the art may know that: With the evolution of the network architecture, the technical solutions provided in the embodiments of this application are also applicable to similar technical problems.

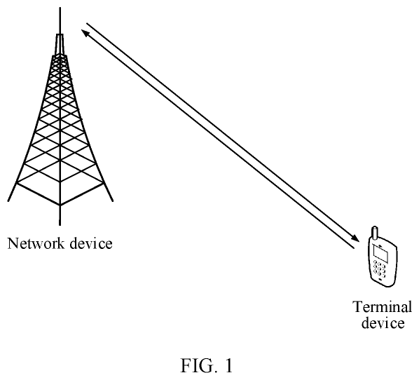

The following describes a network architecture applied to the embodiments of this application. Refer to FIG. 1.

FIG. 1 includes a network device and a terminal, and the terminal is connected to one network device. Certainly, a quantity of terminals in FIG. 1 is only an example. In an actual application, the network device may provide a service for a plurality of terminals. In addition, although the network device and the terminal are shown in the network architecture in FIG. 1, the network architecture may not be limited to including the network device and the terminal, and may further include, for example, a core network device or a device that is configured to perform a virtualized network function. These are obvious to a person of ordinary skill in the art, and are not described one by one in detail herein.

The network device in FIG. 1 is, for example, an access network (access network, AN) device, for example, a base station. The access network device corresponds to different devices in different systems. For example, in a fourth-generation mobile communications technology (4G) system, the access network device may correspond to an eNB, and in a fifth-generation mobile communications technology (5G) system, the access network device corresponds to an access network device in 5G, for example, a gNB.

The following describes, with reference to the accompanying drawings, the technical solutions provided in the embodiments of this application.

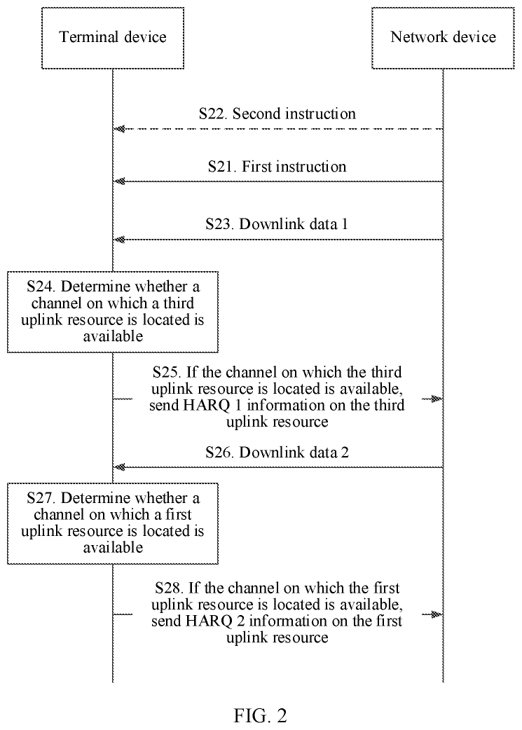

An embodiment of this application provides an information receiving and sending method. FIG. 2 is a flowchart of the method.

In the following description process, for example, the method is applied to the network architecture shown in FIG. 1. The network architecture may work in an unlicensed band, or may work in a licensed band. This is not limited herein. For ease of description, the following uses an example in which the network architecture works in an unlicensed band. In other words, a network device described below may be the network device in the network architecture shown in FIG. 1, and a terminal described below may be the terminal in the network architecture shown in FIG. 1. In addition, the method may be performed by two communications apparatuses. The two communications apparatuses are, for example, a first communications apparatus and a second communications apparatus. The first communications apparatus may be a network device or a communications apparatus that can support a network device in performing a function required by the method, or certainly may be another communications apparatus, for example, a chip system. Similarly, the second communications apparatus may be a terminal or a communications apparatus that can support a terminal in performing a function required by the method, or certainly may be another communications apparatus, for example, a chip system. In addition, implementations of both the first communications apparatus and the second communications apparatus are not limited.

For example, the first communications apparatus may be a network device and the second communications apparatus is a terminal, or the first communications apparatus is a network device and the second communications apparatus is a communications apparatus that can support a terminal in performing a function required by the method.

For ease of description, an example in which the method is performed by a network device and a terminal is used below, that is, an example in which the first communications apparatus is a network device and the second communications apparatus is a terminal is used.

S21. The network device sends a first instruction and the terminal receives the first instruction.

S23. The network device sends downlink data 1 and the terminal receives the downlink data 1.

S24. The terminal determines whether a channel on which a third uplink time-frequency resource is located is available.

S25. If determining that the channel on which the third uplink time-frequency resource is located is available, the terminal sends HARQ 1 information on the third uplink time-frequency resource, and the network device receives the HARQ 1 information on the third uplink time-frequency resource.

S26. The network device sends downlink data 2 and the terminal receives the downlink data 2.

S27. The terminal determines whether a channel on which a first uplink time-frequency resource is located is available.

S28. If determining that the channel on which the first uplink time-frequency resource is located is available, the terminal sends HARQ 2 information on the first uplink time-frequency resource, and the network device receives the HARQ 2 information on the first uplink time-frequency resource.

In this embodiment of this application, in step S21, the first instruction sent by the network device is used to indicate the first uplink time-frequency resource, and the first uplink time-frequency resource may be an uplink control channel resource and/or an uplink shared channel resource.

The following describes the first uplink time-frequency resource.

In this embodiment of this application, the first uplink time-frequency resource is used to carry information that is fed back by the terminal for a received downlink signal or information that is sent by the terminal to estimate a channel state. Specifically, when the network device performs cellular communication with the terminal, for example, when the network device sends downlink data to the terminal, before the network device sends the downlink data, the network device may indicate the terminal to report CSI for channel measurement, to ensure transmission quality. In this way, the network device determines, based on a channel measurement result obtained by using the CSI, a parameter for transmitting the downlink data. For example, a modulation and coding scheme for transmitting the downlink data may be determined based on the CSI. When the CSI indicates a relatively good channel state, a modulation and coding scheme with a relatively high level may be used to increase a data amount of each transmission. When the CSI indicates a relatively poor channel state, a modulation and coding scheme with a relatively low level may be used to reduce a data amount of each transmission. Alternatively, the network device may indicate the terminal to perform HARQ feedback for the downlink data. For example, when the terminal has not received the downlink data or has not correctly received the downlink data, the terminal feeds back a HARQ NACK to the network device, so that the network device retransmits the downlink data based on the HARQ NACK, to reduce a bit error rate of the downlink data. When the terminal has successfully received the downlink data, the terminal feeds back a HARQ ACK to the network device, so that the network device may continue to transmit other downlink data. In this embodiment of this application, the first uplink time-frequency resource may be used to carry one or more of the CSI, the HARQ ACK, and the HARQ NACK. Certainly, the terminal may also send other uplink information, for example, an uplink scheduling request (scheduling request, SR), to the network device. In this case, the first uplink time-frequency resource may also be a resource carrying the other uplink information. These are not listed one by one herein. In this embodiment of this application, a type and content of information carried by the first uplink time-frequency resource are not limited. For ease of description, the following uses an example in which the first uplink time-frequency resource is a physical uplink control channel (physical uplink control channel, PUCCH) resource and the PUCCH carries HARQ information. The HARQ information may be the HARQ ACK or the HARQ NACK.

If the network device sends the downlink data to the terminal on a downlink shared channel resource, the terminal needs to perform HARQ feedback for the received downlink data. For example, downlink data of each transport block (transport block, TB) or each code block group (code block group, CBG) corresponds to HARQ information of one bit, that is, the HARQ feedback may be based on the TB or based on the CBG. In some embodiments, one TB may include a plurality of CBGs. When the downlink data received by the terminal includes a plurality of TBs, HARQ information of the plurality of TBs is fed back together based on TBs or CBGs, to obtain a HARQ codebook, and then the HARQ codebook is fed back to the network device. In this embodiment of this application, it may be understood that the HARQ information may be HARQ information of one bit, or may be a HARQ codebook including a plurality of bits. This is not limited herein. Therefore, before sending the downlink data to the terminal each time, the network device allocates an uplink resource to the HARQ information that needs to be fed back. In this embodiment of this application, the downlink shared channel may be a physical downlink shared channel (physical downlink shared channel, PDSCH), a machine type communication physical downlink control channel (MTC physical downlink shared channel, MPDSCH), a narrowband physical uplink control channel (Narrowband physical downlink shared channel, NPDSCH), or the like. The following uses an example in which the downlink shared channel is a PDSCH.

In some embodiments, the network device may send downlink data to the terminal for more than one time. Downlink data of one time may be data including one or more TBs, or downlink data of one time may be data including one or more CBGs, or the like. For example, after the terminal accesses the channel, the network device may send downlink data to the terminal for a plurality of times. The downlink data of the plurality of times may be marked as downlink data 1 to downlink data n (n is an integer greater than 1). In this case, the first uplink time-frequency resource may be an uplink resource used to carry HARQ information fed back by the terminal for the downlink data 1 to downlink data i, where i is an integer greater than 0 and less than or equal ton. Alternatively, the first uplink time-frequency resource may be an uplink resource used to carry HARQ information fed back by the terminal for downlink data received any time, or the first uplink time-frequency resource may be an uplink resource used to carry an i^{th} piece of HARQ information of the terminal. In this embodiment of this application, the first uplink time-frequency resource is used to carry one or more pieces of first information and one and more pieces of second information of the terminal. The first information and the second information are information that needs to be fed back by the terminal based on scheduling by the base station. The first information includes information that is not sent by the terminal before a first moment because no channel is available. The second information includes information that needs to be fed back on the first uplink time-frequency resource by the terminal based on scheduling by the base station. The first moment corresponds to a start boundary of a first OFDM symbol of the first uplink time-frequency resource or a start boundary of an N^{th} symbol before the first uplink time-frequency resource. N is a positive integer, and N may change depending on different subcarrier bandwidths. Each piece of the one or more pieces of first information and the one and more pieces of second information is information used to perform feedback for received downlink data or information used to estimate a channel state. When there are a plurality of pieces of second information, the plurality of pieces of second information may be different types of information, for example, may be HARQ information fed back by the terminal for downlink data, reported CSI information, or scheduling request SR information. The following uses an example in which the first information and the second information are HARQ information.

Specifically, for example, the first uplink time-frequency resource is an uplink resource scheduled by the network device to carry HARQ information fed back by the terminal for the downlink data i. The HARQ information fed back by the terminal for the downlink data i may be referred to as HARQ i information. If HARQ (i−1) information fed back by the terminal for downlink data (i−1) and HARQ (i−2) information fed back by the terminal for downlink data (i−2) are not sent before the first moment because no channel is available, the HARQ (i−1) information and the HARQ (i−2) information are the plurality of pieces of first information, and the HARQ i information fed back by the terminal for the downlink data i is the second information. For ease of description, the following uses an example in which the network device sends downlink data to the terminal twice, that is, separately sends downlink data 1 and downlink data 2, and the first uplink time-frequency resource is an uplink resource scheduled by the network device to carry HARQ 2 information fed back for the downlink data 2. In this case, the first information may be HARQ 1 information fed back by the terminal for the downlink data 1, and the second information may be the HARQ 2 information fed back by the terminal for the downlink data 2.

If the terminal sends the HARQ 1 information before the first moment, the terminal needs to send only the HARQ 2 information on the first uplink time-frequency resource. If the terminal cannot feed back the HARQ 1 information because no channel is available, the terminal may send the HARQ 1 information and the HARQ 2 information together. In this case, a resource that is indicated by the network device when the network device sends the downlink data 2 and that is used to carry the HARQ 2 information fed back for the downlink data 2 needs to carry the two pieces of HARQ information. Therefore, to deal with resource configuration when a quantity of bits carried by an uplink resource changes due to availability of a channel, in this embodiment of this application, a relatively large uplink resource, that is, the first uplink time-frequency resource, may be allocated to the HARQ 2 information fed back for the downlink data 2. The first uplink time-frequency resource may be used to carry the HARQ 1 information and the HARQ 2 information. To be specific, the first uplink time-frequency resource is capable of carrying the HARQ 1 information and the HARQ 2 information, and whether the terminal sends only the HARQ 2 information or sends both the HARQ 1 information and the HARQ 2 information on the first uplink time-frequency resource may be selected based on an actual situation. This content is described below.

It should be noted that in this embodiment of this application, that no channel is available may be as follows: the terminal performs clear channel assessment (clear channel assessment, CCA) or listen-before-talk (listen-before-talk, LBT) detection on the channel and determines that the channel is occupied, and it indicates that no channel is available, or the terminal may perform CCA or LBT detection on the channel and determine that the channel is in an idle state (that is, unoccupied), but a priority of the HARQ information is relatively low and the channel is used to send other information with a relatively high priority. Certainly, the channel may be unavailable also due to other reasons. Examples are not listed one by one herein. The following describes a manner of determining the first uplink time-frequency resource.

In a first determining manner, the first uplink time-frequency resource is preconfigured.

Specifically, the network device may adjust a volume of downlink data sent each time. For example, a fixed volume of the downlink data 1 sent by the network device is two TBs, and a fixed volume of the downlink data 2 sent by the network device is three TBs. In this case, the network device may learn of a quantity of bits of the HARQ 1 information and the HARQ 2 information in advance. Therefore, the network device may preconfigure the first uplink time-frequency resource. For example, the preconfigured first uplink time-frequency resource may be a resource determined based on a sum of a quantity of bits of the HARQ 1 information and a quantity of bits of the HARQ 2 information. For example, the first uplink time-frequency resource is a resource that carries HARQ information of five bits. Alternatively, the preconfigured first uplink time-frequency resource may be a resource determined based on a larger quantity of bits of the quantity of bits of the HARQ 1 information and the quantity of bits of the HARQ 2 information. For example, if the quantity of bits of the HARQ 2 information is a larger value, that is, three bits, the first uplink time-frequency resource is a resource that carries HARQ information of three bits. Certainly, the first uplink time-frequency resource may also be determined after other processing is performed on the quantity of bits of the HARQ 1 information and the quantity of bits of the HARQ 2 information. Examples are not listed one by one herein.

In a second determining manner, the network device preconfigures a plurality of resource sets, and then determines the first uplink time-frequency resource in the plurality of resource sets.

The network device preconfigures one or more resource sets (resource set) for the terminal. Quantities of bits of HARQ information carried by different resource sets fall into different ranges. For example, a quantity of bits of HARQ information carried by a time-frequency resource included in a resource set 0 is 1 or 2, and a quantity of bits of HARQ information carried by a time-frequency resource included in a resource set 1 is 3 to N bits, where N is configured by using a higher layer parameter. Details are not described herein again. Then, the network device determines a resource in the plurality of resource sets as the first uplink time-frequency resource based on a quantity of bits of HARQ 1 information and HARQ 2 information. For example, the network device may determine the first uplink time-frequency resource based on a sum of a quantity of bits of the HARQ 1 information and a quantity of bits of the HARQ 2 information. Alternatively, the network device may determine the first uplink time-frequency resource based on a larger quantity of bits of the quantity of bits of the HARQ 1 information and the quantity of bits of the HARQ 2 information. Details are not described herein again.

After determining the first uplink time-frequency resource, the network device indicates the first uplink time-frequency resource to the terminal by using the first instruction. Because manners of determining the first uplink time-frequency resource are different, the network device sends the first instruction in manners that may include, but are not limited to, the following two manners:

In a first sending manner, if the first uplink time-frequency resource is preconfigured, the first instruction may be higher layer signaling, for example, may be radio resource control (radio resource control, RRC) signaling, or may be a media access control control element (media access control control element, MAC CE). Certainly, the first instruction may also be other higher layer signaling. Examples are not listed one by one herein. The network device indicates, to the terminal by using the higher layer signaling, a PUCCH resource used to send the HARQ information corresponding to the downlink data 1. The PUCCH resource may be marked as a PUCCH resource of a HARQ 1. For example, the higher layer signaling may directly indicate a PUCCH resource identifier (PUCCH resource ID) of the HARQ 1.

In a second sending manner, if the first uplink time-frequency resource is determined in a plurality of resource sets, a first field of the first instruction indicates that the first uplink time-frequency resource is a resource in a first resource set. The first resource set is determined based on the quantity of bits of the HARQ 1 information and the HARQ 2 information. The first instruction may be downlink control information (downlink control information, DCI). The first field may be a PUCCH resource indicator field/field. For example, the quantity of bits of the HARQ information carried by the time-frequency resource included in the resource set 0 is 1 or 2, and the quantity of bits of the HARQ information carried by the time-frequency resource included in the resource set 1 is 3 to N. If it is determined, based on the sum of the quantity of bits of the HARQ 1 information and the quantity of bits of the HARQ 2 information, that the first resource set is the resource set 1, the PUCCH resource indicator field/field in the first instruction is used to indicate that a resource in the resource set 1 is used as the first uplink time-frequency resource.

Because an unlicensed band is shared, after the network device generates the first instruction, whether a channel in the unlicensed band can be used may be monitored by the network device in one or more bands. For example, the network device separately performs CCA or LBT detection on a channel corresponding to a band 1 of the unlicensed band, a channel corresponding to a band 2, and a channel corresponding to a band 3. When determining that a channel, for example, the channel corresponding to the band 3, is idle and is not occupied by information with a higher priority, the network device sends the first instruction on the channel.

Because the terminal cannot learn of, in advance, whether the network device can use an unlicensed band and cannot learn of, in advance, a band whose corresponding channel is used by the network device to send an instruction, the terminal may receive the first instruction on a plurality of channels in a blind detection manner. The plurality of channels may be channels pre-determined by the network device and the terminal, for example, may be the channel corresponding to the band 1, the channel corresponding to the band 2, and the channel corresponding to the band 3, or may be channels in common search space (common search space, CSS) and specific search space (specific search space, SSS) that are configured by the network device for the terminal. This is not limited herein.

Certainly, the network device and the terminal may agree in advance on a channel to be used. In this case, the network device sends the first instruction on the agreed channel, and the terminal receives the first instruction on the agreed channel.

After receiving the first instruction, the terminal determines the first uplink time-frequency resource based on the first instruction. For example, the terminal may determine, based on the quantity of bits of the HARQ 1 information and the HARQ 2 information, the first resource set in the plurality of resource sets configured by the network device, and then determine the first uplink time-frequency resource in the first resource set based on an indicator field of the first instruction. A process in which the terminal determines the first uplink time-frequency resource and a process in which the network device determines the first uplink time-frequency resource are inverse processes. Details are not described herein again.

In a possible embodiment, before step S21, the method in this embodiment of this application may further include:

S22. The network device sends a second instruction and the terminal receives the second instruction.

In this embodiment of this application, the second instruction is used to indicate a third uplink time-frequency resource. The third uplink time-frequency resource is used to carry one or more pieces of information, that is, the one or more pieces of first information, that is not sent by the terminal before the first symbol of the first uplink time-frequency resource because no channel is available. Alternatively, if the first uplink time-frequency resource is an uplink resource used to carry the HARQ information fed back by the terminal for the downlink data i, the third uplink time-frequency resource may be an uplink resource used to carry the HARQ information fed back by the terminal for the downlink data (i−1). Specifically, for example, the network device sends downlink data to the terminal twice, that is, separately sends downlink data 1 and downlink data 2. In this case, the first uplink time-frequency resource is an uplink resource used to carry the HARQ 2 information fed back for the downlink data 2, and the third uplink time-frequency resource is an uplink resource used to carry the HARQ 1 information fed back for the downlink data 1.

In this embodiment of this application, the third uplink time-frequency resource may be determined by the network device based on the quantity of bits of the HARQ 1 information corresponding to the downlink data 1. For example, the network device and the terminal agree that HARQ information is fed back based on a TB. When the network device sends downlink data of one TB, the terminal correspondingly feeds back HARQ information of one bit, when the network device sends downlink data of two TBs, the terminal correspondingly feeds back HARQ information of two bits, and so on. Therefore, after determining the quantity of bits of the HARQ 1 information corresponding to the downlink data 1, the network device determines the third uplink time-frequency resource based on the quantity of bits of the HARQ 1 information. For example, when the quantity of bits of the HARQ information is one, it is determined that the third uplink time-frequency resource is a resource that carries the HARQ information of one bit. When the quantity of bits of the HARQ information is three bits, it is determined that the third uplink time-frequency resource is a resource that carries the HARQ information of three bits. Certainly, the third uplink time-frequency resource may also carry information other than the HARQ 1 information. In this case, the third uplink time-frequency resource may also be determined based on both a quantity of bits of the other information and the quantity of bits of the HARQ 1 information. A specific determining manner is similar to the manner of determining the first uplink time-frequency resource in S21. Details are not described herein again. The following uses an example in which the third uplink time-frequency resource is used to carry the HARQ 1 information.

The network device sends the second instruction in manners that may include, but are not limited to, the following two manners:

In a first sending manner, the second instruction may be higher layer signaling. A specific indication manner is similar to the first sending manner in S21. Details are not described herein again.

In a second sending manner, the second instruction may be DCI. In this manner, the network device preconfigures one or more resource sets (resource set) for the terminal by using higher layer signaling. Quantities of bits of HARQ information carried by different resource sets fall into different ranges. Then, the network device determines a resource in a resource set as the third uplink time-frequency resource by using a PUCCH resource indicator field (PUCCH resource indicator field)/field in the DCI. A specific process is similar to the second sending manner in S21. Details are not described herein again. After receiving the second instruction, the terminal determines the third uplink time-frequency resource based on the second instruction.

It should be noted that if both the first instruction and the second instruction are DCI, the first instruction and the second instruction may be same DCI, or may be different DCI. When the first instruction and the second instruction are same DCI, it indicates that the first uplink time-frequency resource may be indicated by the second instruction. For example, the first uplink time-frequency resource and the third uplink time-frequency resource are determined in different resource sets by using a PUCCH resource indicator field/field of the second instruction. Specifically, after receiving the downlink data 1, the terminal may determine the second resource set in the plurality of resource sets based on the quantity of bits of the HARQ 1 information, and then determine the third uplink time-frequency resource in the second resource set by using the PUCCH resource indicator field/field of the second instruction; then after receiving the downlink data 2, directly determine the first resource set in the plurality of resource sets based on the quantity of bits of the HARQ 1 information and the HARQ 2 information, and then determine the first uplink time-frequency resource in the first resource set by using the PUCCH resource indicator field/field of the second instruction. Alternatively, the second instruction indicates the first uplink time-frequency resource and the third uplink time-frequency resource by using different indicator fields. For example, an indicator field may be added to DCI, and is used to indicate the first uplink time-frequency resource. After receiving the second instruction, the terminal may determine the third uplink time-frequency resource based on a PUCCH resource indicator field/field of the second instruction, and may determine the first uplink time-frequency resource based on a new indicator field added to the second instruction. A specific determining manner is similar to the foregoing method. Details are not described herein again.

In this embodiment of this application, S22 is an optional step, that is, S22 is not mandatory. It should be noted that in this embodiment of this application, S21 may be performed before S22, or S21 and S22 may be performed simultaneously. This is not limited herein. In FIG. 2, for example, S22 is performed before S21.

S23. The network device sends downlink data 1 and the terminal receives the downlink data 1.

Specifically, the network device may indicate, by using the second instruction or by sending another instruction, a PDSCH resource used by the network device to send the downlink data 1. In this way, after receiving the instruction, the terminal receives, on the corresponding PDSCH resource, the downlink data 1 sent by the network device.

S24. The terminal determines whether a channel on which a third uplink time-frequency resource is located is available.

Specifically, after receiving the downlink data 1 sent by the network device, the terminal needs to determine whether a channel of the third uplink time-frequency resource used to send the HARQ 1 information is available. For example, the terminal may perform CCA detection or LBT detection or the like, to determine whether the channel is available. For example, the terminal listens whether the band corresponding to the third uplink time-frequency resource is occupied by another network or another terminal. If the band corresponding to the third uplink time-frequency resource is not occupied and the terminal has prepared corresponding HARQ information, when the terminal accesses, before a second moment, the channel corresponding to the third uplink time-frequency resource, it indicates that the channel on which the third uplink time-frequency resource is located is available. If the channel corresponding to the third uplink time-frequency resource is not occupied, but the channel is occupied by information with a relatively high priority because a priority of the HARQ 1 information is relatively low, it indicates that the third uplink resource is unavailable. The second moment corresponds to a first OFDM symbol of the third uplink time-frequency resource or an N^{th} symbol before the first uplink time-frequency resource. N is a positive integer, and N may change depending on different subcarrier bandwidths.

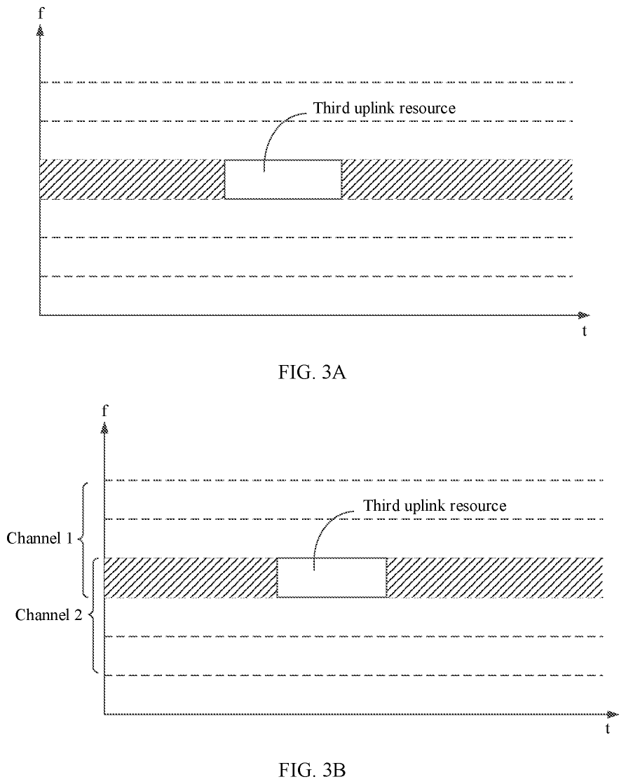

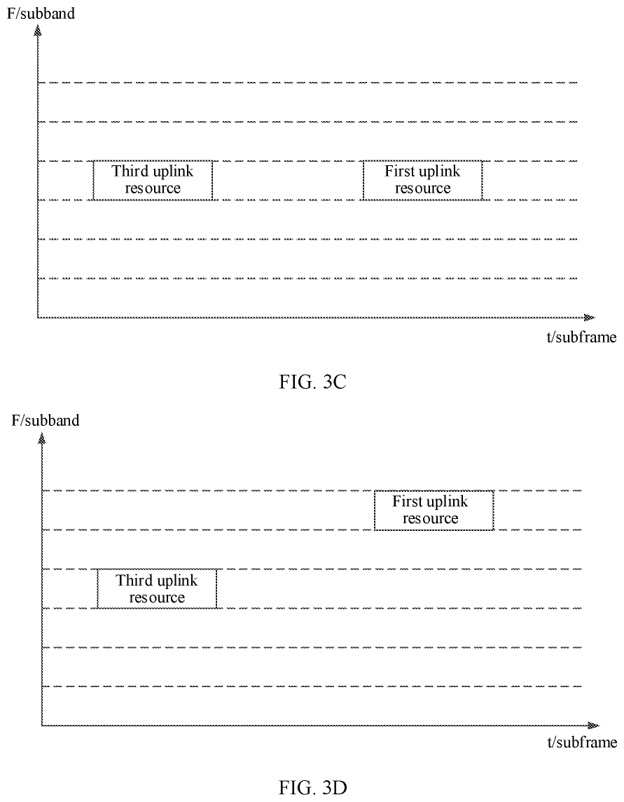

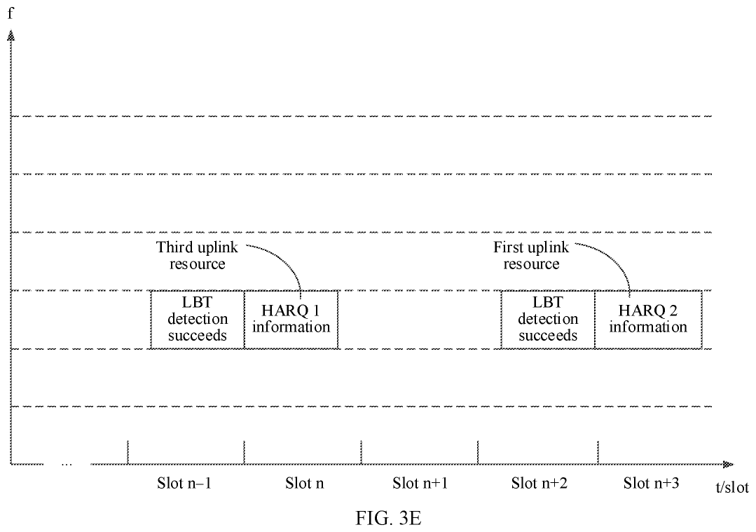

It should be noted that the channel on which the third uplink time-frequency resource is located may be understood in manners that may include, but are not limited to, the following two manners. For example, the third uplink time-frequency resource is in one subband. In a first manner, if one channel is in one subband, the subband on which the third uplink time-frequency resource is located is the channel on which the third uplink time-frequency resource is located, as shown in a shadow portion in FIG. 3A. In a second manner, one channel is in a plurality of subbands. In this case, access to a channel including a subband on which the third uplink time-frequency resource is located is the channel on which the third uplink time-frequency resource is located. As shown in FIG. 3B, both a channel 1 and a channel 2 include the subband on which the third uplink time-frequency resource is located. In this case, the channel 1 or the channel 2 is the channel on which the third uplink time-frequency resource is located. Certainly, there may also be other cases and are not listed one by one herein.

In addition, it should be noted that the first uplink time-frequency resource and the third uplink time-frequency resource may be located in a same subcarrier or subband, or different subcarriers or subbands. As shown in FIG. 3C, the first uplink time-frequency resource and the third uplink time-frequency resource are located in a same subband, and a time-domain location of the third uplink time-frequency resource is before that of the first uplink time-frequency resource. As shown in FIG. 3D, the first uplink time-frequency resource and the third uplink time-frequency resource are located in different subbands, and a time-domain location of the third uplink time-frequency resource is before that of the first uplink time-frequency resource.

S25. If determining that the channel on which the third uplink time-frequency resource is located is available, the terminal sends HARQ 1 information on the third uplink time-frequency resource, and the network device receives the HARQ 1 information on the third uplink time-frequency resource.

Because the terminal has received the downlink data 1 sent by the network device, when the terminal determines that the channel of the third uplink time-frequency resource is available, the terminal sends the HARQ 1 information on the third uplink time-frequency resource, as shown in FIG. 3E.

S26. The network device sends downlink data 2 and the terminal receives the downlink data 2.

S27. The terminal determines whether a channel on which a first uplink time-frequency resource is located is available.

S26 and S27 are similar to S23 and S24. Details are not described herein again.

S28. If determining that the channel on which the first uplink time-frequency resource is located is available, the terminal sends HARQ 2 information on the first uplink time-frequency resource, and the network device receives the HARQ 2 information on the first uplink time-frequency resource.

Because the terminal has received the downlink data 2 sent by the network device, when the terminal determines that the channel on which the first uplink time-frequency resource is located is available, the terminal sends the HARQ 2 information on the first uplink time-frequency resource. As shown in FIG. 3E, successful LBT detection indicates that the channel on which the third uplink time-frequency resource or the first uplink time-frequency resource is located is available.

For example, the HARQ 2 information is sent on the first uplink time-frequency resource in manners that may include, but are not limited to, the following two manners:

A first manner is as follows:

Preset information is sent at a first resource location of the first uplink time-frequency resource, and the HARQ 2 information is sent at a second resource location of the first uplink time-frequency resource.

The first resource location is a resource location reserved for the HARQ 1 information, and the second resource location is a remaining resource location of the first uplink time-frequency resource other than the first resource location. The preset information is an acknowledgment ACK message, a negative acknowledgment NACK message, or a combination of an ACK and a NACK.

Specifically, the first uplink time-frequency resource may be divided into two parts. One part is used to carry the HARQ 1 information, and the other part is used to carry the HARQ 2 information. Because the HARQ 1 information has been sent previously on the third uplink time-frequency resource, a resource location that is of the first uplink time-frequency resource and that is used to carry the HARQ 1 information is filled with the preset information. For example, the HARQ 1 information includes four bits, and the HARQ 2 information includes two bits and is “01”. A NACK, an ACK, or a combination of an ACK and a NACK, or a value obtained by performing exclusive OR cyclically on every two bits of a codebook based on the HARQ 1 information is sent on four bits reserved in the first uplink time-frequency resource for the HARQ 1 information. ACKs and NACKs may be combined in an interleaving manner of ACK NACK ACK NACK . . . , or a manner of ACK ACK NACK NACK . . . , or another combination manner. This is not limited herein. If the first four bits that are in the first uplink time-frequency resource and that are used to carry HARQ information are reserved for the HARQ 1 information, the terminal encodes the preset information and then maps the encoded preset information to the four bits, and then encodes the HARQ 2 information and maps the encoded HARQ 2 information to other subsequent bits. It should be noted that the terminal and the network device may agree on filled information in advance.

A second manner is as follows:

Combined information of the HARQ 2 information and preset information is sent on the first uplink time-frequency resource.

Specifically, ACK information or NACK information and the HARQ 2 information may be combined and then sent. For example, the combined information may be information obtained after the ACK information and the HARQ 2 information are jointly encoded, or may be information obtained after the NACK information and the HARQ 2 information are jointly encoded, or information obtained after an exclusive OR operation or a logical operation is performed on the ACK information and the HARQ 2 information. Examples are not described one by one herein.

After detecting the information on the first uplink time-frequency resource, the network device may obtain the HARQ 2 information based on the combined information of the preset information and the HARQ 2.

According to the foregoing technical solution, the first uplink time-frequency resource is set as a resource used to carry a plurality of pieces of information. In this way, when the terminal successfully accesses a channel and sends all information before a time-domain location corresponding to the first uplink time-frequency resource, the terminal may send, on the uplink resource, combined information of information that needs to be sent after the terminal successfully accesses the channel currently and the preset information, and a quantity of bits carried by the first uplink time-frequency resource does not change. Therefore, this can deal with resource configuration when the quantity of bits carried by the first uplink time-frequency resource changes due to availability of a channel.

In the embodiment shown in FIG. 2, an information sending process after the terminal determines that a channel on which a time-frequency resource is located is available before the time-frequency resource allocated by the network device to the terminal is described. Another embodiment is described below, to describe an information sending process when a terminal determines that a channel on which a time-frequency resource is located is unavailable before the time-frequency resource allocated by a network device to the terminal.

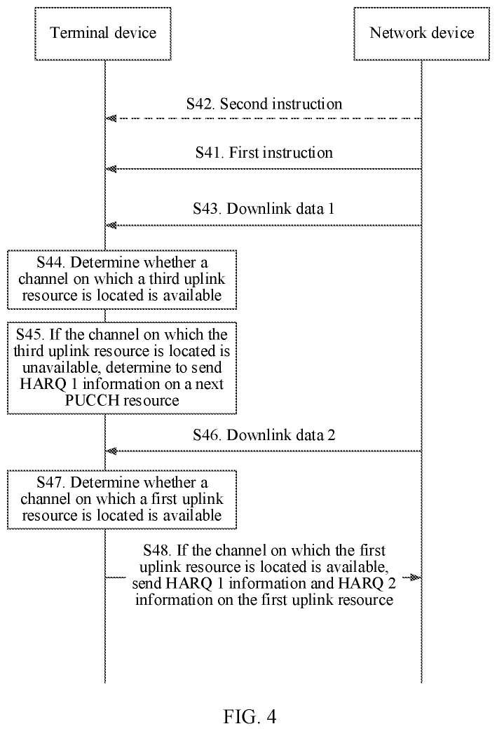

An embodiment of this application provides an information receiving and sending method. FIG. 4 is a flowchart of the method.

In the following description process, for example, the method is applied to the network architecture shown in FIG. 1. In other words, a network device described below may be the network device in the network architecture shown in FIG. 1, and a terminal described below may be the terminal in the network architecture shown in FIG. 1. In addition, the method may be performed by two communications apparatuses. The two communications apparatuses are, for example, a first communications apparatus and a second communications apparatus. The first communications apparatus and the second communications apparatus are respectively similar to the first communications apparatus and the second communications apparatus in the embodiment shown in FIG. 2. Details are not described herein again.

For ease of description, an example in which the method is performed by a network device and a terminal is used below, that is, an example in which the first communications apparatus is a network device and the second communications apparatus is a terminal is used.

S41. The network device sends a first instruction and the terminal receives the first instruction.

In an implementation, before S41, the method may further include:

S42. The network device sends a second instruction and the terminal receives the second instruction.

S43. The network device sends downlink data 1 and the terminal receives the downlink data 1.

S44. The terminal determines whether a channel on which a third uplink time-frequency resource is located is available.

S41 to S44 are similar to S21 to S24. Details are not described herein again.

S45. If determining that the channel on which the third uplink time-frequency resource is located is unavailable, the terminal determines to send HARQ 1 information on a first uplink time-frequency resource.

Because the terminal determines that the channel on which the third uplink time-frequency resource is located is unavailable, the terminal cannot use a PUCCH resource of the HARQ 1 to send the HARQ 1 information, and therefore continues to wait for a next PUCCH resource, that is, the first uplink time-frequency resource and sends the HARQ 1 information on the first uplink time-frequency resource. It should be noted that determining, by the terminal, that the channel on which the third uplink time-frequency resource is located is unavailable is, for example, finding that the channel is not idle by performing CCA or LBT, or the channel is occupied by information with a higher priority. Details are not described herein again.

S46. The network device sends downlink data 2 and the terminal receives the downlink data 2.

S47. The terminal determines whether a channel on which the first uplink time-frequency resource is located is available.

S46 and S47 are similar to S26 and S27. Details are not described herein again.

S48. If determining that the channel on which the first uplink time-frequency resource is located is available, the terminal sends HARQ 1 information and HARQ 2 information on the first uplink time-frequency resource, and the network device receives the HARQ 1 information and the HARQ 2 information on the first uplink time-frequency resource.

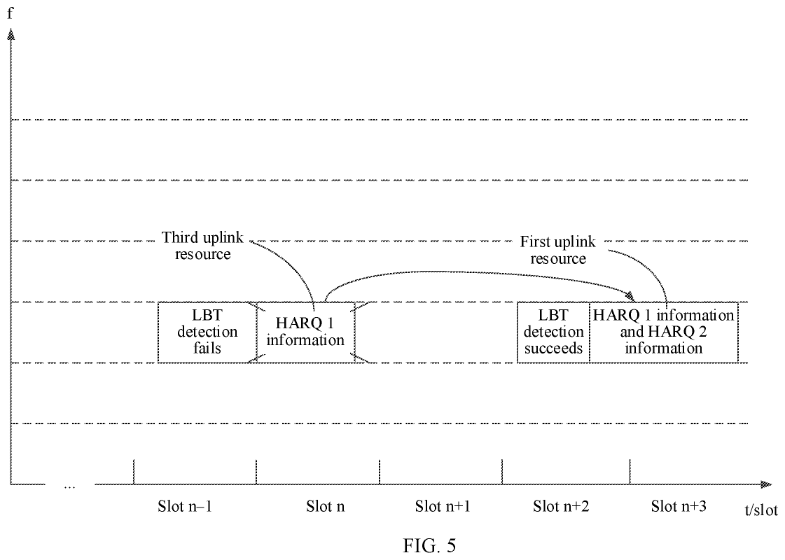

When the terminal determines that the channel on which the first uplink time-frequency resource is located is available, the terminal sends the HARQ 1 information and the HARQ 2 information on the first uplink time-frequency resource, as shown in FIG. 5.

For example, the HARQ 1 information and the HARQ 2 information are sent on the first uplink time-frequency resource in manners that may include, but are not limited to, the following manners:

The first uplink time-frequency resource is used to carry the HARQ 1 information and the HARQ 2 information, and the HARQ 1 information and the HARQ 2 information are included in a same HARQ-ACK codebook.

Alternatively, the first uplink time-frequency resource is used to carry information that is obtained after the HARQ 1 information and the HARQ 2 information are jointly encoded, and the HARQ 1 information and the HARQ 2 information are included in different HARQ-ACK codebooks.

Alternatively, the first uplink time-frequency resource is used to carry information that is obtained after the HARQ 1 information and the HARQ 2 information are separately encoded, and the HARQ 1 information and the HARQ 2 information are included in different HARQ-ACK codebooks.

Alternatively, the first uplink time-frequency resource is used to carry information that is obtained after a logical operation is performed on the HARQ 1 information and the HARQ 2 information.

It should be noted that the logical operation performed on the HARQ 1 information and the HARQ 2 information may include, for example, a logical AND operation or an exclusive OR operation. Certainly, the HARQ 1 information and the HARQ 2 information may also be sent in another manner. Examples are not listed one by one herein. In addition, a manner of processing performed by the terminal on the HARQ 1 information and the HARQ 2 information may be agreed on with the network device in advance, or may be reported by the terminal to the network device. This is not limited herein.

After detecting the information on the first uplink time-frequency resource, the network device may distinguish the HARQ 1 information from the HARQ 2 information in the information, for example, distinguish HARQ information in a predefined manner, and for example, first encode the HARQ 1 information and then encode the HARQ 2 information.

According to the foregoing technical solution, the first uplink time-frequency resource is set as a resource used to carry a plurality of pieces of information. In this way, when there is information, for example, the HARQ 1 information, that is not sent by the terminal before the first symbol of the first uplink time-frequency resource because no channel is available, the terminal may send, on the first uplink time-frequency resource, the HARQ 1 information and information, for example, the HARQ 2 information, that needs to be sent during the current feedback. A quantity of bits carried by the first uplink time-frequency resource does not change. Therefore, this can deal with resource configuration when the quantity of bits carried by the first uplink time-frequency resource changes due to availability of a channel.

In the embodiment shown in FIG. 4, an information sending process in which the network device allocates one time-frequency resource to the terminal is described. Another embodiment is described below, to describe an information sending process in which a network device allocates a plurality of time-frequency resources to a terminal.

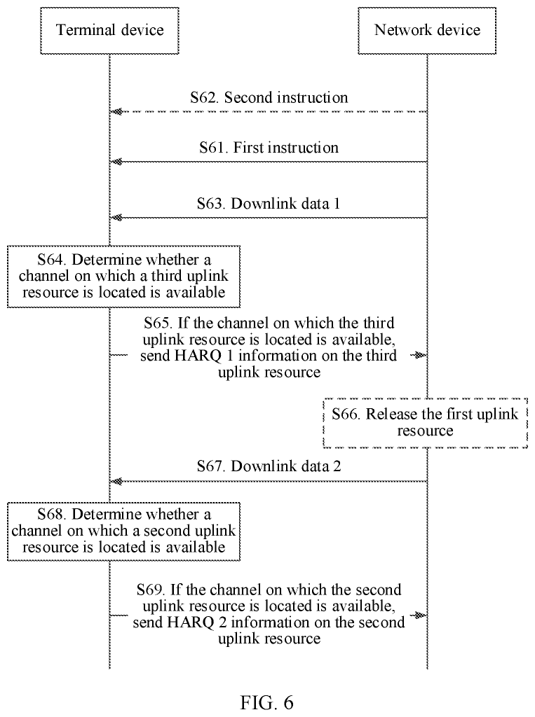

An embodiment of this application provides an information receiving and sending method. FIG. 6 is a flowchart of the method.

In the following description process, for example, the method is applied to the network architecture shown in FIG. 1. In other words, a network device described below may be the network device in the network architecture shown in FIG. 1, and a terminal described below may be the terminal in the network architecture shown in FIG. 1. In addition, the method may be performed by two communications apparatuses. The two communications apparatuses are, for example, a first communications apparatus and a second communications apparatus. The first communications apparatus and the second communications apparatus are respectively similar to the first communications apparatus and the second communications apparatus in the embodiment shown in FIG. 2. Details are not described herein again.

For ease of description, an example in which the method is performed by a network device and a terminal is used below, that is, an example in which the first communications apparatus is a network device and the second communications apparatus is a terminal is used.

S61. The network device sends a first instruction and the terminal receives the first instruction.

The first instruction is used to indicate a first uplink time-frequency resource. The first uplink time-frequency resource is similar to the first uplink time-frequency resource in S21. Details are not described herein again. The following uses an example in which the first uplink time-frequency resource carries one piece of first information and one piece of second information, the first information is HARQ 1 information, and the second information is HARQ 2 information.

Different from S21 and S41, in this embodiment of this application, the first instruction is further used to indicate a second uplink time-frequency resource. The second uplink time-frequency resource is used to carry one or more pieces of second information. The following uses an example in which the second uplink time-frequency resource carries one piece of the second information, that is, the HARQ 2 information.

In this embodiment of this application, the network device may indicate two uplink resources, that is, the first uplink time-frequency resource and the second uplink time-frequency resource, to the terminal by using the first instruction. The first uplink time-frequency resource may be used to carry the HARQ 1 information and the HARQ 2 information, and the second uplink time-frequency resource is used to carry only the HARQ 2 information. If the terminal sends the HARQ 1 information before the first symbol of the first uplink time-frequency resource, the terminal needs to send only the HARQ 2 information when feeding back HARQ information next time. If the terminal cannot feed back the HARQ 1 information because no channel is available, the terminal needs to send both the HARQ 1 information and the HARQ 2 information when feeding back HARQ information next time. In this case, when the terminal feeds back HARQ information, a quantity of bits carried by the uplink resource changes depending on whether a channel of the uplink resource is available. Therefore, to deal with resource configuration when the quantity of bits carried by the uplink resource changes due to availability of a channel, in this embodiment of this application, two uplink resources, namely, the first uplink time-frequency resource and the second uplink time-frequency resource, may be allocated to the HARQ 2 information fed back for the downlink data 2. The first uplink time-frequency resource may be used to carry the HARQ 1 information and the HARQ 2 information, and the second uplink time-frequency resource may be used to carry the HARQ 2 information. In other words, when the terminal needs to send only the HARQ 2 information, the terminal sends the HARQ 2 information on the second uplink time-frequency resource. When the terminal needs to send both the HARQ 1 information and the HARQ 2 information, the terminal sends both the HARQ 1 information and the HARQ 2 information on the first uplink time-frequency resource. A specific sending situation of the terminal may be selected based on an actual situation. This content is described below.

The following describes a manner of determining the first uplink time-frequency resource and the second uplink time-frequency resource. A manner of determining the first uplink time-frequency resource is similar to that in S21. Details are not described herein again. In this embodiment of this application, the second uplink time-frequency resource is determined in manners that include, but are not limited to, the following two manners.

In a first determining manner, the second uplink time-frequency resource is preconfigured.

Specifically, the network device may adjust a volume of downlink data sent each time. For example, a fixed volume of the downlink data 1 sent by the network device is two TBs, and a fixed volume of the downlink data 2 sent by the network device is three TBs. In this case, the network device may learn of a quantity of bits of the HARQ 2 in advance. Therefore, the network device may preconfigure the second uplink time-frequency resource. For example, the preconfigured second uplink time-frequency resource may be a resource determined based on a quantity of bits of the HARQ 2. For example, the second uplink time-frequency resource is a resource that carries a HARQ of three bits.

In a second determining manner, the network device preconfigures a plurality of resource sets, and then determines the second uplink time-frequency resource in the plurality of resource sets.

The network device preconfigures one or more resource sets (resource set) for the terminal. Quantities of bits of HARQ information carried by different resource sets fall into different ranges. For example, a quantity of bits of HARQ information carried by a time-frequency resource included in a resource set 2 is 1 or 2, and a quantity of bits of HARQ information carried by a time-frequency resource included in a resource set 3 is 3 to N bits, where N is configured by using a higher layer parameter. Details are not described herein again. Then, the network device determines a resource in the resource set 2 and the resource set 3 as the second uplink time-frequency resource based on a quantity of bits of HARQ 2 information. For example, the network device may determine the second uplink time-frequency resource based on the quantity of bits of the HARQ 2 information.

It should be noted that the resource set 2 may be similar to the resource set 0 used to determine the first uplink time-frequency resource, and the resource set 3 may be similar to the resource set 1 used to determine the first uplink time-frequency resource. Certainly, the resource set 2 and the resource set 3 may also be resource sets different from the resource set 0 and the resource set 1. That is, the network device configures a plurality of resource sets for each of the first uplink time-frequency resource and the second uplink time-frequency resource. This is not limited herein. The following uses an example in which the resource set 2 is similar to the resource set 0 used to determine the first uplink time-frequency resource, and the resource set 3 is similar to the resource set 1 used to determine the first uplink time-frequency resource.

After determining the first uplink time-frequency resource and the second uplink time-frequency resource, the network device indicates the first uplink time-frequency resource and the second uplink time-frequency resource to the terminal by using the first instruction. Because manners of determining the first uplink time-frequency resource and the second uplink time-frequency resource are different, the network device sends the first instruction in manners that may include, but are not limited to, the following three manners:

In a first sending manner, if the first uplink time-frequency resource and the second uplink time-frequency resource are preconfigured, the first instruction may be higher layer signaling. A specific indication manner is similar to the first sending manner in S21. Details are not described herein again.

In a second sending manner, if the first uplink time-frequency resource and the second uplink time-frequency resource are determined in a plurality of resource sets, a first field of the first instruction indicates the first uplink time-frequency resource and the second uplink time-frequency resource. In other words, the network device sends one piece of signaling to indicate the two uplink resources. The first instruction may be DCI. The first field may be a PUCCH resource indicator field/field. Specifically, depending on different resource sets to which the first uplink time-frequency resource and the second uplink time-frequency resource belong, content indicated by the first field includes the following two cases:

In a first case, a first resource set is different from a second resource set.

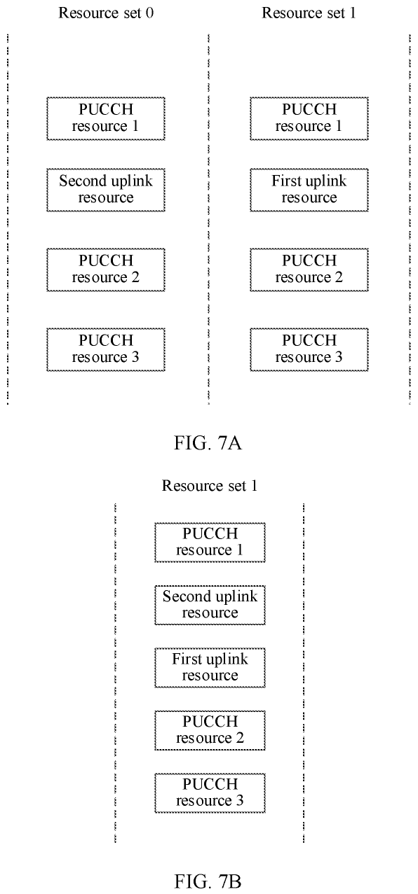

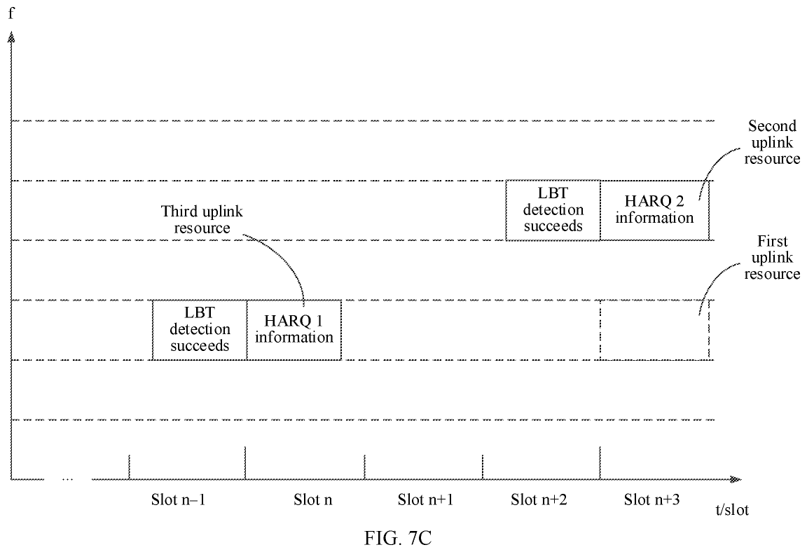

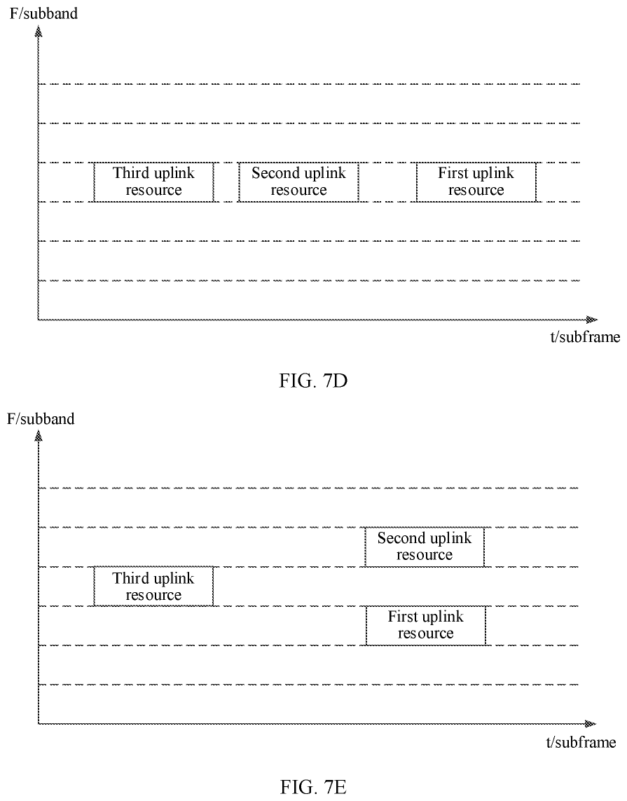

In this case, the first field of the first instruction is used to indicate that the first uplink time-frequency resource is a resource in the first resource set, and is used to indicate that the second uplink time-frequency resource is a resource in the second resource set. For example, referring to FIG. 7A, a quantity of bits of the HARQ information carried by the time-frequency resource included in the resource set 0 configured by the network device is 1 or 2, and a quantity of bits of the HARQ information carried by the time-frequency resource included in the resource set 1 is 3 to N. When the quantity of bits of the HARQ 2 information is two, and a sum of the quantity of bits of the HARQ 1 information and the quantity of bits of the HARQ 2 information is four, the first resource set is the resource set 1 and the second resource set is the resource set 0. Therefore, the first field of the first instruction is used to indicate that a resource in the resource set 1 is the first uplink time-frequency resource, and a resource in the resource set 0 is the second uplink time-frequency resource.

In a second case, a first resource set is the same as a second resource set.

In this case, the first field of the first instruction is used to indicate that the first uplink time-frequency resource is a resource in the first resource set, and a value of a field obtained after the first field is processed is used to indicate that the second uplink time-frequency resource is a resource in the second resource set. A manner of processing the first field may be performing bitwise inversion on the first field or adding a preset offset to the first field, or certainly may be another processing manner. These are not listed one by one herein. For example, referring to FIG. 7B, if the quantity of bits of the HARQ 2 information is three, and a sum of the quantity of bits of the HARQ 1 information and the quantity of bits of the HARQ 2 information is five, both the first resource set and the second resource set are the resource set 1. Therefore, the first field of the first instruction is used to indicate that a resource in the resource set 1 is used as the first uplink time-frequency resource, and a field obtained after the first field is processed indicates that another resource in the resource set 1 is used as the second uplink time-frequency resource.

In addition, in this sending manner, different fields of the first instruction may also be used to indicate the first uplink time-frequency resource and the second uplink time-frequency resource. For example, a field may be added to the first instruction, and the field is used to indicate the second uplink time-frequency resource. A specific form of the added new field is not limited herein.

In a third sending manner, if the first uplink time-frequency resource and the second uplink time-frequency resource are determined in a plurality of resource sets, the first field of the first instruction indicates the second uplink time-frequency resource, and the first field of the second instruction is used to indicate the first uplink time-frequency resource. In other words, the network device indicates the two uplink resources by using two pieces of signaling, and in addition to a PUCCH resource of the HARQ 1 information, the second instruction may further indicate the first uplink time-frequency resource. In this manner, the first resource set is the same as the second resource set. In other words, the network device indicates different resources in a same resource set separately as the first uplink time-frequency resource and the second uplink time-frequency resource by using first fields of different pieces of signaling. Content of a specific indication is similar to that in the second sending manner. Details are not described herein again.

Then, the network device determines, based on the corresponding step in S21, whether a channel on which the first uplink time-frequency resource is located is available. When the channel is available, the network device sends the first instruction on the channel in one of the foregoing plurality of sending manners. The terminal receives the first instruction based on the corresponding step in S21. Details are not described herein again.

After receiving the first instruction, the terminal determines the first uplink time-frequency resource and the second uplink time-frequency resource based on the first instruction. For example, the network device sends the first instruction in a sending manner agreed on with the terminal, for example, in the first case of the second sending manner. In this case, the terminal may determine, in a plurality of resource sets configured by the network device, the first resource set corresponding to the sum of the quantity of bits of the HARQ 1 information and the quantity of bits of the HARQ 2 information, and then determine the first uplink time-frequency resource in the first resource set based on an indicator field of the first instruction; and determine, in the plurality of resource sets configured by the network device, the second resource set corresponding to the quantity of bits of the HARQ 2 information, and then determine the second uplink time-frequency resource in the second resource set based on an indicator field of the first instruction.

In an implementation, before S61, the method may further include:

S62. The network device sends a second instruction and the terminal receives the second instruction.

In addition, it should be noted that the first uplink time-frequency resource, the second uplink time-frequency resource, and the third uplink time-frequency resource may be located in a same subcarrier or subband, or different subcarriers or subbands. As shown in FIG. 7D, the first uplink time-frequency resource, the second uplink time-frequency resource, and the third uplink time-frequency resource are located in a same subband, and both a time-domain location of the second uplink time-frequency resource and a time-domain location of the third uplink time-frequency resource are before that of the first uplink time-frequency resource. As shown in FIG. 7E, the first uplink time-frequency resource, the second uplink time-frequency resource, and the third uplink time-frequency resource are located in different subbands, and a time-domain location of the third uplink time-frequency resource is before that of the first uplink time-frequency resource. The time-domain location of the second uplink time-frequency resource and the time-domain location of the first uplink time-frequency resource may be the same, as shown in FIG. 7E, or may be different, as shown in FIG. 7D. This is not limited herein.

S62 is an optional step, that is, S62 is not mandatory.

S63. The network device sends downlink data 1 and the terminal receives the downlink data 1.

S64. The terminal determines whether a channel on which a third uplink time-frequency resource is located is available.

S65. If determining that the channel on which the third uplink time-frequency resource is located is available, the terminal sends HARQ 1 information on the third uplink time-frequency resource, and the network device receives the HARQ 1 information on the third uplink time-frequency resource.

S62 to S65 are similar to S22 and S25. Details are not described herein again.

S66. The network device releases the first uplink time-frequency resource.

After receiving the HARQ 1 information on the third uplink time-frequency resource, the network device determines that the terminal sends no information on the first uplink time-frequency resource. Therefore, the network device may release the first uplink time-frequency resource, as shown in FIG. 7C. Therefore, the first uplink time-frequency resource may be used by another terminal, thereby saving resources. In FIG. 7C, a dashed line is used to indicate that the first uplink time-frequency resource is released.

It should be noted that S66 is an optional step, that is, S66 is not mandatory.

S67. The network device sends downlink data 2 and the terminal receives the downlink data 2.

S68. The terminal determines whether a channel on which a second uplink time-frequency resource is located is available.

S67 and S68 are similar to S26 and S27. Details are not described herein again.

S69. If determining that the channel on which the second uplink time-frequency resource is located is available, the terminal sends HARQ 2 information on the second uplink time-frequency resource, and the network device receives the HARQ 2 information on the second uplink time-frequency resource.

Because the terminal sends the HARQ 1 information on the third uplink time-frequency resource, the terminal needs to send, during the current feedback, only the HARQ 2 information corresponding to the downlink data 2. Therefore, the terminal accesses a second uplink channel, and after the access succeeds, sends the HARQ 2 information on the second uplink time-frequency resource, as shown in FIG. 7B.

According to the foregoing technical solution, the two uplink resources are allocated to transmit uplink information once. For example, one resource is used to carry uplink information that needs to be fed back currently, and the other resource is used to carry uplink information that needs to be fed back currently and information that is not sent before the current feedback because no channel is accessed. In this way, the terminal may select, based on whether the terminal successfully accesses the channel, one of the resources to send the uplink information. Therefore, both quantities of bits carried by the two uplink resources allocated to transmit the uplink information do not change. Therefore, this can deal with resource configuration when the quantity of bits carried by the first uplink time-frequency resource changes due to availability of a channel.

In the embodiment shown in FIG. 6, an information sending process after the terminal determines that a channel is available before the time-frequency resource allocated by the network device to the terminal is described. Another embodiment is described below, to describe an information sending process when a terminal determines that no channel is available before a time-frequency resource allocated by a network device to the terminal.

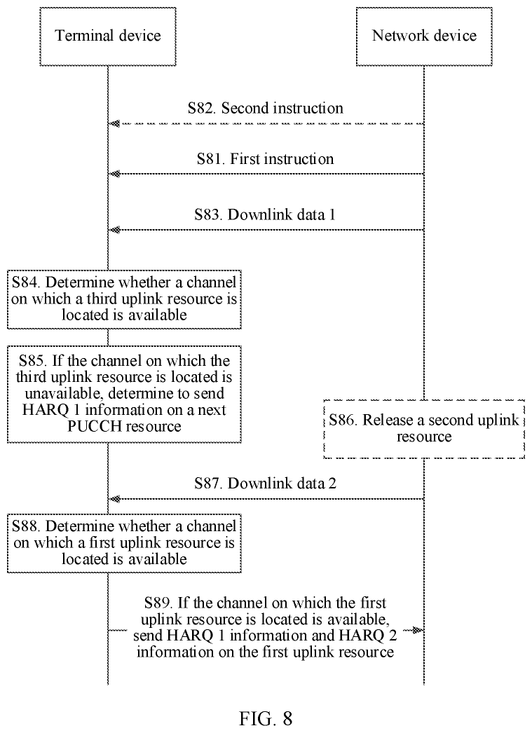

An embodiment of this application provides an information receiving and sending method. FIG. 8 is a flowchart of the method.

In the following description process, for example, the method is applied to the network architecture shown in FIG. 1. In other words, a network device described below may be the network device in the network architecture shown in FIG. 1, and a terminal described below may be the terminal in the network architecture shown in FIG. 1. In addition, the method may be performed by two communications apparatuses. The two communications apparatuses are, for example, a first communications apparatus and a second communications apparatus. The first communications apparatus and the second communications apparatus are respectively similar to the first communications apparatus and the second communications apparatus in the embodiment shown in FIG. 2. Details are not described herein again.

For ease of description, an example in which the method is performed by a network device and a terminal is used below, that is, an example in which the first communications apparatus is a network device and the second communications apparatus is a terminal is used.

S81. The network device sends a first instruction and the terminal receives the first instruction.

In an implementation, before S81, the method may further include:

S82. The network device sends a second instruction and the terminal receives the second instruction.

S83. The network device sends downlink data 1 and the terminal receives the downlink data 1.

S84. The terminal determines whether a channel on which a third uplink time-frequency resource is located is available.

S81 to S84 are similar to S61 to S64. Details are not described herein again.

S85. If determining that the channel on which the third uplink time-frequency resource is located is unavailable, the terminal determines to send HARQ 1 information on the first uplink time-frequency resource.

Because the terminal determines that the channel on which the third uplink time-frequency resource is located is unavailable, the terminal cannot send the HARQ 1 information by using the third uplink time-frequency resource, and therefore continues to wait to send the HARQ 1 information on a next PUCCH resource.

S86. The network device releases the third uplink time-frequency resource.

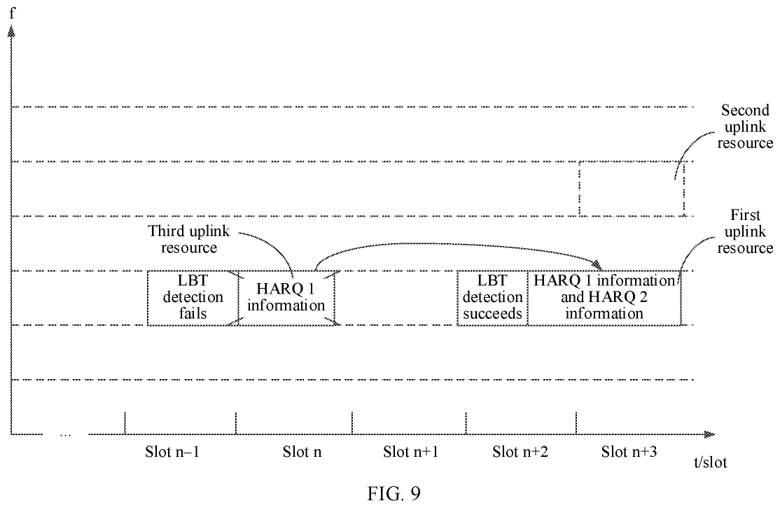

Because the network device has not received the HARQ 1 information on the third uplink time-frequency resource, the network device determines that the terminal sends the HARQ 1 information together with the HARQ 2 information, and needs to send the information on the first uplink time-frequency resource. Therefore, the network device may release the second uplink time-frequency resource, as shown in FIG. 9. Therefore, the second uplink time-frequency resource may be used by another terminal, thereby saving resources. In FIG. 9, a dashed line is used to indicate that the second uplink time-frequency resource is released.

It should be noted that S86 is an optional step, that is, S86 is not mandatory.

S87. The network device sends downlink data 2 and the terminal receives the downlink data 2.

S88. The terminal determines whether a channel on which the first uplink time-frequency resource is located is available.

S87 and S88 are similar to S67 and S68. Details are not described herein again.

S89. If determining that the channel on which the first uplink time-frequency resource is located is available, the terminal sends HARQ 1 information and HARQ 2 information on the first uplink time-frequency resource, and the network device receives the HARQ 1 information and the HARQ 2 information on the first uplink time-frequency resource.

Because the terminal has not sent the HARQ 1 information on the third uplink time-frequency resource, the terminal needs to send the HARQ 1 information and the HARQ 2 information during the current feedback. Therefore, the terminal accesses a channel on which the first uplink time-frequency resource is located. After the access succeeds, the terminal sends the HARQ 1 information and the HARQ 2 information on the first uplink time-frequency resource, as shown in FIG. 9.

It should be noted that S89 is similar to S48. Details are not described herein again.

According to the foregoing technical solution, the two uplink resources are allocated to transmit uplink information once. For example, one resource is used to carry uplink information that needs to be fed back currently, and the other resource is used to carry uplink information that needs to be fed back currently and information that is not sent before the current feedback because no channel is accessed. In this way, the terminal may select, based on whether the terminal successfully accesses the channel, one of the resources to send the uplink information. Therefore, both quantities of bits carried by the two uplink resources allocated to transmit the uplink information do not change. Therefore, this can deal with resource configuration when the quantity of bits carried by the first uplink time-frequency resource changes due to availability of a channel.

Further, the network device may detect whether energy exists on the first uplink time-frequency resource and the second uplink time-frequency resource, to further determine whether information sent by the terminal is fed back once or for a plurality of times.

In the foregoing embodiments provided in this application, the methods provided in the embodiments of this application are separately described from perspectives of a network device, a terminal, and interaction between a network device and a terminal. To perform functions in the methods provided in the embodiments of this application, the network device and the terminal may include a hardware structure and/or a software module, and perform the foregoing functions in a form of a hardware structure, a software module, or a hardware structure plus a software module. Whether one of the foregoing functions is performed in a form of a hardware structure, a software module, or a hardware structure plus a software module depends on a specific application and a design constraint condition of the technical solutions.

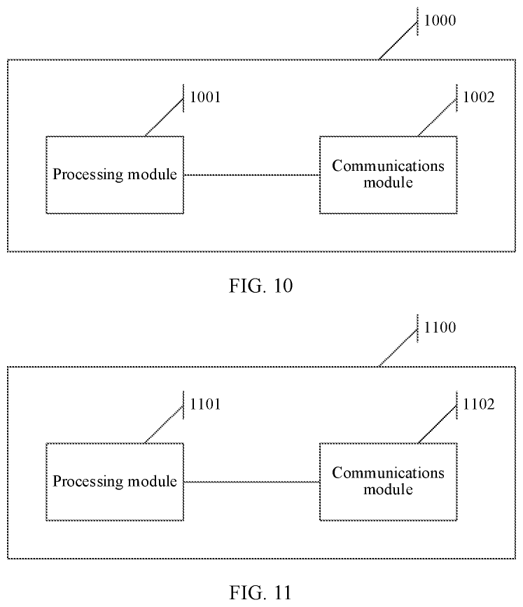

FIG. 10 is a schematic structural diagram of a communications apparatus 1000. The communications apparatus 1000 may be a terminal, and can perform a function of the terminal in the methods provided in the embodiments of this application. Alternatively, the communications apparatus 1000 may be an apparatus that can support a terminal in performing the function of the terminal in the methods provided in the embodiments of this application. The communications apparatus 1000 may be a hardware structure, a software module, or a hardware structure plus a software module. The communications apparatus 1000 may be implemented by a chip system. In this embodiment of this application, the chip system may include a chip, or may include a chip and another discrete device.

The communications apparatus 1000 may include a processing module 1001 and a communications module 1002.

The processing module 1001 may be configured to perform step S24 and step S27 in the embodiment shown in FIG. 2, or may be configured to perform step S44, step S45, and step S47 in the embodiment shown in FIG. 4, or may be configured to perform step S64 and step S68 in the embodiment shown in FIG. 6, or may be configured to perform step S84, step S85, and step S88 in the embodiment shown in FIG. 8, and/or may be configured to support another process of the technology described in this specification. The communications module 1002 is used by the communications apparatus 1000 to communicate with another module, and may be a circuit, a device, an interface, a bus, a software module, a transceiver, or any other apparatus that can implement communication.

The communications module 1002 may be configured to perform step S21 to step S23, step S25, step S26, and step S28 in the embodiment shown in FIG. 2, or may be configured to perform step S41 to step S43, step S46, and step S48 in the embodiment shown in FIG. 4, or may be configured to perform step S61 to step S63, step S65, step S67, and step S69 in the embodiment shown in FIG. 6, or may be configured to perform step S81 to step S83, step S87, and step S89 in the embodiment shown in FIG. 8, and/or may be configured to support another process of the technology described in this specification.

All related content of the steps in the foregoing method embodiments may be referenced to function descriptions of corresponding functional modules. Details are not described herein again.

FIG. 11 is a schematic structural diagram of a communications apparatus 1100. The communications apparatus 1100 may be a network device, and can perform a function of the network device in the methods provided in the embodiments of this application. Alternatively, the communications apparatus 1100 may be an apparatus that can support a network device in performing a function of the network device in the methods provided in the embodiments of this application. The communications apparatus 1100 may be a hardware structure, a software module, or a hardware structure plus a software module. The communications apparatus 1100 may be implemented by a chip system. In this embodiment of this application, the chip system may include a chip, or may include a chip and another discrete device.

The communications apparatus 1100 may include a processing module 1101 and a communications module 1102.

The processing module 1101 may be configured to control the communications module 1102 to send an instruction, for example, a first instruction or a second instruction, or may be configured to perform step S66 in the embodiment shown in FIG. 6, or may be configured to perform step S86 in the embodiment shown in FIG. 8, and/or may be configured to support another process of the technology described in this specification. The communications module 1102 is used by the communications apparatus 1100 to communicate with another module, and may be a circuit, a device, an interface, a bus, a software module, a transceiver, or any other apparatus that can implement communication.

The communications module 1102 may be configured to perform step S21 to step S23, step S25, step S26, and step S28 in the embodiment shown in FIG. 2, or may be configured to perform step S41 to step S43, step S46, and step S48 in the embodiment shown in FIG. 4, or may be configured to perform step S61 to step S63, step S65, step S67, and step S69 in the embodiment shown in FIG. 6, or may be configured to perform step S81 to step S83, step S87, and step S89 in the embodiment shown in FIG. 8, and/or may be configured to support another process of the technology described in this specification.

All related content of the steps in the foregoing method embodiments may be referenced to function descriptions of corresponding functional modules. Details are not described herein again.

Module division in the embodiments of this application is an example, and is only logical function division. In an actual implementation, there may be another division manner. In addition, various functional modules in the embodiments of this application may be integrated into one processor or may exist alone physically, or two or more modules may be integrated into one module. The integrated module may be implemented in a form of hardware, or may be implemented in a form of a software functional module.

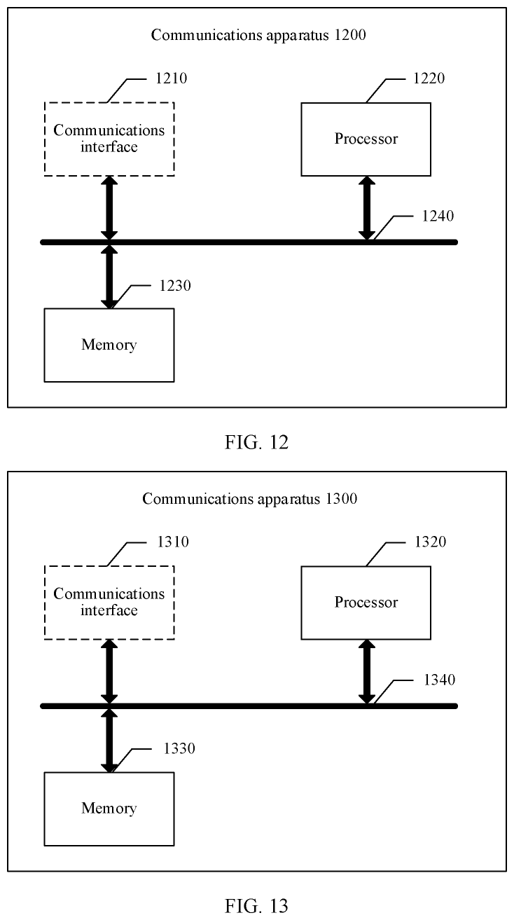

FIG. 12 shows a communications apparatus 1200 according to an embodiment of this application. The communications apparatus 1200 may be the terminal in the embodiment shown in FIG. 2, FIG. 4, FIG. 6, or FIG. 8, and can perform a function of the terminal in the methods provided in the embodiments of this application. Alternatively, the communications apparatus 1200 may be an apparatus that can support a terminal in performing the function of the terminal in the methods provided in the embodiments of this application. The communications apparatus 1200 may be a chip system. In this embodiment of this application, the chip system may include a chip, or may include a chip and another discrete device.

The communications apparatus 1200 includes at least one processor 1220, configured to implement or support the communications apparatus 1200 in implementing the function of the terminal in the methods provided in the embodiments of this application. For example, the processor 1220 may determine whether a channel on which an uplink resource is located is available. For details, refer to detailed descriptions in the method examples. Details are not described again.

The communications apparatus 1200 may further include at least one memory 1230, configured to store a program instruction and/or data. The memory 1230 is coupled to the processor 1220. The coupling in this embodiment of this application is an indirect coupling or a communication connection between apparatuses, units, or modules, and may be in an electrical, mechanical, or another form, and is used for information exchange between apparatuses, units, or modules. The processor 1220 may cooperate with the memory 1230 in an operation. The processor 1220 may execute the program instruction stored in the memory 1230. At least one of the at least one memory may be included in the processor.

The communications apparatus 1200 may further include a communications interface 1210, configured to communicate with another device by using a transmission medium, so that an apparatus used in the communications apparatus 1200 may communicate with the another device. For example, the another device may be a network device. The processor 1220 may send and receive data by using the communications interface 1210.

A specific connection medium among the communications interface 1210, the processor 1220, and the memory 1230 is not limited in this embodiment of this application. In this embodiment of this application, the memory 1230, the processor 1220, and the communications interface 1210 are connected by using a bus 1240 in FIG. 12. The bus is represented by a thick line in FIG. 12. A manner of connection between other components is only an example for description and is not limited thereto. The bus may be classified into an address bus, a data bus, a control bus, and the like. For ease of representation, only one thick line is used to represent the bus in FIG. 12, but this does not mean that there is only one bus or only one type of bus.

In the embodiments of this application, the processor 1220 may be a general-purpose processor, a digital signal processor, an application-specific integrated circuit, a field programmable gate array or another programmable logic device, a discrete gate or transistor logic device, or a discrete hardware component, and may implement or execute the methods, steps, and logical block diagrams disclosed in the embodiments of this application. The general purpose processor may be a microprocessor or any conventional processor or the like. The steps of the method disclosed with reference to the embodiments of this application may be directly performed by a hardware processor, or may be performed by using a combination of hardware in the processor and a software module.

In this embodiment of this application, the memory 1230 may be a non-volatile memory, for example, a hard disk drive (hard disk drive, HDD) or a solid-state drive (solid-state drive, SSD), or may be a volatile memory (volatile memory), for example, a random-access memory (random-access memory, RAM). The memory is any other medium that can be configured to carry or store desired program code in a form of an instruction or a data structure and that can be accessed by a computer, but is not limited thereto. The memory in this embodiment of this application may alternatively be a circuit or any other apparatus that can implement a storage function, and is configured to store a program instruction and/or data.

FIG. 13 shows a communications apparatus 1300 according to an embodiment of this application. The communications apparatus 1300 may be a network device, and can perform a function of the network device in the methods provided in the embodiments of this application. Alternatively, the communications apparatus 1300 may be an apparatus that can support a core network element in performing the function of the network device in the methods provided in the embodiments of this application. The communications apparatus 1300 may be a chip system. In this embodiment of this application, the chip system may include a chip, or may include a chip and another discrete device.

The communications apparatus 1300 includes at least one processor 1320, configured to implement or support the communications apparatus 1300 in implementing a function of the core network element in the methods provided in the embodiments of this application. For example, the processor 1320 may control the communications interface 1310 to send an instruction. For details, refer to detailed descriptions in the method examples. Details are not described again.

The communications apparatus 1300 may further include at least one memory 1330, configured to store a program instruction and/or data. The memory 1330 is coupled to the processor 1320. The coupling in this embodiment of this application is an indirect coupling or a communication connection between apparatuses, units, or modules, and may be in an electrical, mechanical, or another form, and is used for information exchange between apparatuses, units, or modules. The processor 1320 may cooperate with the memory 1330 in an operation. The processor 1330 may execute the program instruction stored in the memory 1320. At least one of the at least one memory may be included in the processor.

The communications apparatus 1300 may further include a communications interface 1310, configured to communicate with another device by using a transmission medium, so that an apparatus used in the communications apparatus 1300 may communicate with the another device. For example, the another device may be a terminal. The processor 1320 may send and receive data by using the communications interface 1310.

A specific connection medium among the communications interface 1310, the processor 1320, and the memory 1330 is not limited in this embodiment of this application. In this embodiment of this application, the memory 1330, the processor 1320, and the communications interface 1310 are connected by using a bus 1340 in FIG. 13. The bus is represented by a thick line in FIG. 13. A manner of connection between other components is only an example for description and is not limited thereto. The bus may be classified into an address bus, a data bus, a control bus, and the like. For ease of representation, only one thick line is used to represent the bus in FIG. 13, but this does not mean that there is only one bus or only one type of bus.

In the embodiments of this application, the processor 1320 may be a general-purpose processor, a digital signal processor, an application-specific integrated circuit, a field programmable gate array or another programmable logic device, a discrete gate or transistor logic device, or a discrete hardware component, and may implement or execute the methods, steps, and logical block diagrams disclosed in the embodiments of this application. The general purpose processor may be a microprocessor or any conventional processor or the like. The steps of the method disclosed with reference to the embodiments of this application may be directly performed by a hardware processor, or may be performed by using a combination of hardware in the processor and a software module.

In this embodiment of this application, the memory 1330 may be a non-volatile memory, for example, a hard disk drive (hard disk drive, HDD) or a solid-state drive (solid-state drive, SSD), or may be a volatile memory (volatile memory), for example, a random-access memory (random-access memory, RAM). The memory is any other medium that can be configured to carry or store desired program code in a form of an instruction or a data structure and that can be accessed by a computer, but is not limited thereto. The memory in this embodiment of this application may alternatively be a circuit or any other apparatus that can implement a storage function, and is configured to store a program instruction and/or data.

An embodiment of this application further provides a computer readable storage medium, including an instruction. When the instruction is run on a computer, the computer is enabled to perform the method performed by the terminal in any one of the embodiments in FIG. 2, FIG. 4, FIG. 6, and FIG. 8.

An embodiment of this application further provides a computer readable storage medium, including an instruction. When the instruction is run on a computer, the computer is enabled to perform the method performed by the network device in any one of the embodiments in FIG. 2, FIG. 4, FIG. 6, and FIG. 8.

An embodiment of this application further provides a computer program product, including an instruction. When the computer program product runs on a computer, the computer is enabled to perform the method performed by the terminal in any one of the embodiments in FIG. 2, FIG. 4, FIG. 6, and FIG. 8.

An embodiment of this application further provides a computer program product, including an instruction. When the computer program product runs on a computer, the computer is enabled to perform the method performed by the network device in any one of the embodiments in FIG. 2, FIG. 4, FIG. 6, and FIG. 8.

An embodiment of this application provides a chip system. The chip system includes a processor and may further include a memory, and is configured to implement a function of the terminal in the foregoing methods. The chip system may include a chip, or may include a chip and another discrete device.

An embodiment of this application provides a chip system. The chip system includes a processor and may further include a memory, and is configured to implement a function of the network device in the foregoing methods. The chip system may include a chip, or may include a chip and another discrete device.

An embodiment of this application provides a system. The system includes the foregoing terminal and the foregoing network device.

All or some of the foregoing methods in the embodiments of this application may be implemented by software, hardware, firmware, or any combination thereof. When software is used to implement the embodiments, the embodiments may be implemented completely or partially in a form of a computer program product. The computer program product includes one or more computer instructions. When the computer program instructions are loaded and executed on the computer, the procedure or functions according to the embodiments of the present invention are all or partially generated. The computer may be a general-purpose computer, a dedicated computer, a computer network, a network device, a user device, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (digital subscriber line, DSL for short)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a digital video disc (digital video disc, DVD for short), a semiconductor medium (for example, an SSD), or the like.

It is clearly that, a person skilled in the art can make various modifications and variations to this application without departing from the scope of this application. This application is intended to cover these modifications and variations of this application provided that they fall within the scope of protection defined by the following claims and their equivalent technologies.

What is claimed is:

1. An information receiving method, comprising:
sending, by a network device, a first instruction, wherein the first instruction is used to indicate a first uplink time-frequency resource, and the first uplink time-frequency resource is used to carry one or more pieces of first information and one or more pieces of second information of a terminal, wherein
the first information comprises information that is not sent by the terminal before a first moment because no channel is available, the second information comprises information that is transmitted on the first uplink time-frequency resource by the terminal and that is scheduled by the network device, and the first uplink time-frequency resource is an uplink control channel resource and/or an uplink shared channel resource; and
receiving, by the network device, at least one piece of the one or more pieces of first information and the one or more pieces of second information on the first uplink time-frequency resource.

2. The method according to claim 1, wherein a first field of the first instruction is used to indicate that the first uplink time-frequency resource is a resource in a first resource set, the first resource set is determined based on a quantity of bits of the one or more pieces of first information and the one and more pieces of second information, and the quantity of bits is a sum of a quantity of bits of the one or more pieces of first information and a quantity of bits of the one and more pieces of second information, or is a larger quantity of bits of a quantity of bits of the one or more pieces of first information and a quantity of bits of the one and more pieces of second information.

3. The method according to claim 1, wherein a second field of the first instruction is used to indicate a second uplink time-frequency resource in a second resource set, the second resource set is determined based on the quantity of bits of the one or more pieces of second information, and if the second resource set is determined based on a quantity of bits of the plurality of pieces of second information, the quantity of bits is a sum of quantities of bits of the plurality of pieces of second information or is a largest quantity of bits of quantities of bits of the plurality of pieces of second information.

4. The method according to claim 1, wherein that the first uplink time-frequency resource is used to carry one or more pieces of first information and one and more pieces of second information of a terminal comprises:
the first uplink time-frequency resource is used to carry the one or more pieces of first information and the one and more pieces of second information, and the one or more pieces of first information and the one and more pieces of second information are comprised in a same HARQ-ACK codebook;
the first uplink time-frequency resource is used to carry information that is obtained after the one or more pieces of first information and the one and more pieces of second information are jointly encoded, and the one or more pieces of first information and the one and more pieces of second information are comprised in different HARQ-ACK codebooks;
the first uplink time-frequency resource is used to carry information that is obtained after the one or more pieces of first information and the one and more pieces of second information are separately encoded, and the one or more pieces of first information and the one and more pieces of second information are comprised in different HARQ-ACK codebooks; or
the first uplink time-frequency resource is used to carry information that is obtained after a logical operation is performed on the one or more pieces of first information and the one and more pieces of second information.

5. The method according to claim 1, wherein each piece of the one or more pieces of first information and the one and more pieces of second information is HARQ information used to perform feedback for a received downlink signal or CSI information used to estimate a channel state.

6. An information sending method, comprising:
receiving, by a terminal, a first instruction, wherein the first instruction is used to indicate a first uplink time-frequency resource, and the first uplink time-frequency resource is used to carry one or more pieces of first information and one and more pieces of second information of the terminal, wherein
the first information comprises information that is not sent by the terminal before a first moment because no channel is available, the second information comprises information that is transmitted on the first uplink time-frequency resource by the terminal and that is scheduled by the network device, and the first uplink time-frequency resource is an uplink control channel resource and/or an uplink shared channel resource; and
sending, by the terminal, at least one piece of the one or more pieces of first information and the one and more pieces of second information on the first uplink time-frequency resource after a channel is available.

7. The method according to claim 6, wherein a first field of the first instruction is used to indicate that the first uplink time-frequency resource is a resource in a first resource set, the first resource set is determined based on a quantity of bits of the one or more pieces of first information and the one and more pieces of second information, and the quantity of bits is a sum of a quantity of bits of the one or more pieces of first information and a quantity of bits of the one and more pieces of second information, or is a larger quantity of bits of a quantity of bits of the one or more pieces of first information and a quantity of bits of the one and more pieces of second information.

8. The method according to claim 6, wherein a second field of the first instruction is used to indicate a second uplink time-frequency resource in a second resource set, the second resource set is determined based on the quantity of bits of the one or more pieces of second information, and if the second resource set is determined based on a quantity of bits of the plurality of pieces of second information, the quantity of bits is a sum of quantities of bits of the plurality of pieces of second information or is a largest quantity of bits of quantities of bits of the plurality of pieces of second information.

9. The method according to claim 8, wherein the channel is available for the terminal after the first moment, and the sending, by the terminal, at least one piece of the one or more pieces of first information and the one and more pieces of second information on the first uplink time-frequency resource comprises:
if the first information is not sent before the first moment, sending, by the terminal, the one or more pieces of first information and the one and more pieces of second information on the first uplink time-frequency resource.

10. The method according to claim 8, wherein the terminal may use the channel after the first moment, and the sending, by the terminal, at least one piece of the one and more pieces of second information on the second uplink time-frequency resource comprises:
if the first information is sent before the first moment, sending, by the terminal, the one or more pieces of second information on the second uplink time-frequency resource.

11. The method according to claim 10, wherein the sending, by the terminal, the one and more pieces of second information on the first uplink time-frequency resource comprises:
sending preset information at a first resource location and sending the one or more pieces of second information at a second resource location, wherein the first resource location is a resource location reserved for the one or more pieces of first information, and the second resource location is a remaining resource location on the first uplink time-frequency resource other than the first resource location; or
sending combined information of the one or more pieces of second information and the preset information on the second uplink time-frequency resource; wherein
the preset information is an acknowledgment ACK message, a negative acknowledgment NACK message, or a combination of an ACK and a NACK.

12. The method according to claim 6, wherein that the first uplink time-frequency resource is used to carry one or more pieces of first information and one or more pieces of second information of the terminal comprises:
the first uplink time-frequency resource is used to carry the one or more pieces of first information and the one and more pieces of second information, and the one or more pieces of first information and the one and more pieces of second information are comprised in a same HARQ-ACK codebook;
the first uplink time-frequency resource is used to carry information that is obtained after the one or more pieces of first information and the one and more pieces of second information are jointly encoded, and the one or more pieces of first information and the one and more pieces of second information are comprised in different HARQ-ACK codebooks;
the first uplink time-frequency resource is used to carry information that is obtained after the one or more pieces of first information and the one and more pieces of second information are separately encoded, and the one or more pieces of first information and the one and more pieces of second information are comprised in different HARQ-ACK codebooks; or
the first uplink time-frequency resource is used to carry information that is obtained after a logical operation is performed on the one or more pieces of first information and the one and more pieces of second information.

13. The method according to claim 6, wherein each piece of the one or more pieces of first information and the one and more pieces of second information is information used to perform feedback for a received downlink signal or information used to estimate a channel state.

14. A communications apparatus, comprising a processor and a communications interface, wherein
the communications interface is configured to send a first instruction under control of the processor, wherein the first instruction is used to indicate a first uplink time-frequency resource, and the first uplink time-frequency resource is used to carry one or more pieces of first information and one or more pieces of second information of a terminal;
the first information comprises information that is not sent by the terminal before a first moment because no channel is available, the second information comprises information that is transmitted on the first uplink time-frequency resource by the terminal and that is scheduled by the communications apparatus, and the first uplink time-frequency resource is an uplink control channel resource and/or an uplink shared channel resource; and
the communications interface is configured to receive at least one piece of the one or more pieces of first information and the one and more pieces of second information on the first uplink time-frequency resource.

15. The communications apparatus according to claim 14, wherein a first field of the first instruction is used to indicate that the first uplink time-frequency resource is a resource in a first resource set, the first resource set is determined based on a quantity of bits of the one or more pieces of first information and the one and more pieces of second information, and the quantity of bits is a sum of a quantity of bits of the one or more pieces of first information and a quantity of bits of the one and more pieces of second information, or is a larger quantity of bits of a quantity of bits of the one or more pieces of first information and a quantity of bits of the one and more pieces of second information.

16. The communications apparatus according to claim 14, wherein a second field of the first instruction is used to indicate a second uplink time-frequency resource in a second resource set, the second resource set is determined based on the quantity of bits of the one or more pieces of second information, and if the second resource set is determined based on a quantity of bits of the plurality of pieces of second information, the quantity of bits is a sum of quantities of bits of the plurality of pieces of second information or is a largest quantity of bits of quantities of bits of the plurality of pieces of second information.

17. The communications apparatus according to claim 14, wherein that the first uplink time-frequency resource is used to carry one or more pieces of first information and one and more pieces of second information of a terminal comprises:
the first uplink time-frequency resource is used to carry the one or more pieces of first information and the one and more pieces of second information, and the one or more pieces of first information and the one and more pieces of second information are comprised in a same HARQ-ACK codebook;
the first uplink time-frequency resource is used to carry information that is obtained after the one or more pieces of first information and the one and more pieces of second information are jointly encoded, and the one or more pieces of first information and the one and more pieces of second information are comprised in different HARQ-ACK codebooks;
the first uplink time-frequency resource is used to carry information that is obtained after the one or more pieces of first information and the one and more pieces of second information are separately encoded, and the one or more pieces of first information and the one and more pieces of second information are comprised in different HARQ-ACK codebooks; or
the first uplink time-frequency resource is used to carry information that is obtained after a logical operation is performed on the one or more pieces of first information and the one and more pieces of second information.

18. The communications apparatus according to claim 14, wherein each piece of the one or more pieces of first information and the one and more pieces of second information is HARQ information used to perform feedback for a received downlink signal or CSI information used to estimate a channel state.

19. A communications apparatus, comprising a processor and a communications interface, wherein
the communications interface is configured to receive a first instruction, wherein the first instruction is used to indicate a first uplink time-frequency resource, and the first uplink time-frequency resource is used to carry one or more pieces of first information and one and more pieces of second information of the communications apparatus;
the first information comprises information that is not sent by the communication apparatus before a first moment because no channel is available, the second information comprises information that is transmitted on the first uplink time-frequency resource by the communications apparatus and that is scheduled by the network device, and the first uplink time-frequency resource is an uplink control channel resource and/or an uplink shared channel resource; and
the communications interface is configured to send at least one piece of the one or more pieces of first information and the one and more pieces of second information on the first uplink time-frequency resource after a channel is available under control of the processor.

20. The communications apparatus according to claim 19, wherein a first field of the first instruction is used to indicate that the first uplink time-frequency resource is a resource in a first resource set, the first resource set is determined based on a quantity of bits of the one or more pieces of first information and the one and more pieces of second information, and the quantity of bits is a sum of a quantity of bits of the one or more pieces of first information and a quantity of bits of the one and more pieces of second information, or is a larger quantity of bits of a quantity of bits of the one or more pieces of first information and a quantity of bits of the one and more pieces of second information.
